(19) United States
(12) Patent Application Publication
(10) Pub. No.: US 2013/0336597 A1
(43) Pub. Date: Dec. 19, 2013

(54) IMAGE STABILIZATION APPARATUS, IMAGE STABILIZATION METHOD, AND DOCUMENT

(71) Applicants: Tomohide Maeda, Fukuoka (JP); Mariko Takenouchi, Osaka (JP); Mikio Morioka, Fukuoka (JP)

(72) Inventors: Tomohide Maeda, Fukuoka (JP); Mariko Takenouchi, Osaka (JP); Mikio Morioka, Fukuoka (JP)

(73) Assignee: PANASONIC CORPORATION, Kadoma-shi, Osaka (JP)

(21) Appl. No.: 14/001,725

(22) PCT Filed: Jun. 15, 2012
(86) PCT No.: PCT/JP2012/003933

§ 371 Date: Aug. 27, 2013

(30) Foreign Application Priority Data
Jun. 17, 2011 (JP) 2011-134926

(51) Int. Cl. G06T 5/00

(52) U.S. Cl. CPC G06T 5/003
USPC 382/275

(57) ABSTRACT

Image stabilization apparatus includes: layout marker detection unit that detects a layout marker from a photographed image; estimation marker position calculation unit that obtains a position of a PSF estimation marker; estimation marker size calculation unit that obtains a size of the PSF estimation marker; estimation marker reference image generating unit that generates an image of the PSF estimation marker to be a reference; PSF calculation unit that estimates a PSF by using the estimation marker image to be the reference and an estimation marker image corresponding thereto in the photographed image; and image stabilization unit that corrects blurring in the photographed image by using the estimated PSF.

### TECHNICAL FIELD

The present invention relates to an image stabilization apparatus, an image stabilization method and a document and more particularly, relates to a technique for correcting blurring in an image (blurring in an image caused by camera shake, to be precise) by using a PSF (Point Spread Function).

### BACKGROUND ART

Conventionally, there are portable terminal devices each provided with a camera and configured to photograph a document such as a check or receipt, for example, and then perform image recognition on the photographed image. Many devices of this kind include a function for correcting blurring in an image because camera shake at the time of photographing causes blurring in an image.

As a method for correcting such image blurring in a still image by image processing, a technique using PSFs (Point Spread Functions) is known. A PSF is a function that represents the way blurring appears. Deconvolution of the PSF on the photographed image having image blurring enables recovery of a sharp image that could have been obtained otherwise.

One method for estimating a PSF is Blind Deconvolution. Blind Deconvolution is a method that assumes a feature (gradient distribution) included in a sharp natural image, and stochastically derives a PSF and a recovered image that is likely and satisfies the assumption only from an input image. Drawbacks of Blind Deconvolution include its enormous amount of operations, low accuracy in the estimated PSF, and low robustness with respect to input images.

In this respect, a method that uses an additional sensor is considered. This method adds a rate sensor to a camera, acquires motion information on the camera during an exposure period to generate a trajectory of camera shake by using the rate sensor, and estimates the trajectory of the camera shake as a PSF.

Further, as an image-blurring correction method using a PSF, there is a method disclosed in Patent Literature 1. The method uses an ideal image of an edge and an actually photographed image. The overview of the method will be explained. The technique of Patent Literature 1 aims at a stationary-type finger and palm print image input device and estimates a PSF unique to a device based on an actual edge data formed by photographing an edge image whose pattern is predetermined and ideal edge data formed by the ideal edge image. Next, based on the estimated PSF, an input finger and palm print image is corrected by a deconvolution filter to obtain a sharp image having no device specific influence.

### CITATION LIST

### Patent Literature

[PTL 1]
Japanese Patent Application Laid-Open No. 2000-40146
[PTL 2]
Japanese Patent Application Laid-Open No. HEI 4-14960

### SUMMARY OF INVENTION

### Technical Problem

Here, the use of an external sensor such as a rate sensor requires the installation of the sensor to the camera. Thus, there is a drawback that the structure is more complicated for the presence of the SENSOR. Further, another drawback is a larger error of the estimated PSF (the error from the actual PSF becomes large since the obtained trajectory of the camera shake has a shape formed by connecting line segments and there is no line width information).

Further, since the technique disclosed in Patent Literature 1 requires fixing a positional relationship between a photographic subject and a camera, the technique has a drawback in that it is difficult to apply the technique to image stabilization for a hand-held camera. Further, since it is premised on the photographing of an actual edge image whose patterns are limited to edges, user operations for the setting are necessary, and in addition to the photographing, a photographing step for PSF estimation is necessary. Therefore, there is a drawback of involving time and effort in photographing.

The present invention is made in view of the above described circumstances, and an object of the invention is thus to provide an image stabilization apparatus, an image stabilization method and a document that enable highly accurate image stabilization with a relatively small amount of operations, a simple configuration as well as easy user operations in correcting image blurring using a PSF.

### Solution to Problem

An image stabilization apparatus according to one aspect of the present invention includes: an image receiving unit that receives a photographed image including a layout marker and a PSF estimation marker; a layout marker detection unit that detects a layout marker from the photographed image; a marker information keeping unit that keeps information on the layout marker; an estimation marker position calculation unit that obtains a position of the PSF estimation marker based on a result of layout marker detection obtained by the layout marker detection unit and the information on the layout marker kept in the marker information keeping unit; an estimation marker size calculation unit that obtains a size of the PSF estimation marker based on the result of layout marker detection obtained by the layout marker detection unit and the information on the layout marker kept by the marker information keeping unit; an estimation marker reference image generating unit that generates an image of the PSF estimation marker to be a reference based on the size of the PSF estimation marker obtained by the estimation marker size calculation unit; an estimation marker position associating unit that associates a position of the image of the PSF estimation marker to be the reference obtained by the estimation marker reference image generating unit with a position of the image of the PSF estimation marker in the photographed image based on the position of the PSF estimation marker obtained by the estimation marker position calculation unit; a PSF estimation unit that estimates a PSF by using the image of the PSF estimation marker to be the reference and the image of the PSF estimation marker in the photographed image, which are associated with each other by the estimation marker position associating unit; and an image stabilization unit that corrects blurring in the image by using the estimated PSF.

To achieve at least one of the abovementioned objects, an image stabilization method according to one aspect of the present invention includes: a layout marker detection step of detecting a layout marker from a photographed image including a layout marker and a PSF estimation marker; an estimation marker position calculation step of obtaining a position of the PSF estimation marker based on the detected layout marker; an estimation marker size calculation step of obtaining a size of the PSF estimation marker based on the detected layout marker; an estimation marker reference image generating step of generating an image of the PSF estimation marker to be a reference based on the calculated size of the PSF estimation marker; an estimation marker position associating step of associating a position of the generated image of the PSF estimation marker to be the reference and a position of the image of the PSF estimation marker in the photographed image based on the calculated position of the PSF estimation marker; a PSF estimation step of estimating a PSF by using the image of the PSF estimation marker to be the reference and the image of the PSF estimation marker in the photographed image, which are associated with each other; and an image stabilization step of correcting blurring in the photographed image by using the estimated PSF.

A document according to one aspect of the present invention includes: a reading frame; a character entry area provided within the reading frame; first and second layout markers respectively formed at positions within the reading frame, the positions being located across the character entry area from one another; and a PSF estimation marker formed at a position within the reading frame and between the first and second layout markers.

### Advantageous Effect of Invention

According to the present invention, it is made possible to perform highly accurate image stabilization with a relatively small amount of operations, a simple configuration as well as easy user operations in correcting image blurring using a PSF.

### BRIEF DESCRIPTION OF DRAWINGS

FIG. 1 is a diagram showing image stabilization according to an embodiment:

FIG. 2 is a diagram showing an overview of processes of the embodiment;

FIG. 3 is a block diagram showing a basic configuration of an image stabilization apparatus of the embodiment;

FIG. 4 is a flowchart showing a procedure performed by the image stabilization apparatus;

FIG. 5 is a diagram showing an exemplary configuration of a document of the embodiment;

FIG. 6 is a flowchart showing a procedure performed by an estimation marker position calculation unit;

FIG. 7 is a diagram for explaining a distance between layout markers calculated from photographed images;

FIG. 8 is a diagram showing layout information of the document read from a marker information keeping unit;

FIG. 9 is a flowchart showing a procedure performed by an estimation marker size calculation unit;

FIG. 10 is a diagram for explaining PSF estimation marker information read from the marker information keeping unit;

FIG. 11 is a flowchart showing a procedure performed by an estimation marker reference image generating unit;

FIG. 12 is a diagram showing a rendering example of a reference image of a PSF estimation marker (where a marker shape is a circle);

FIG. 13 is a block diagram showing an exemplary configuration of a PSF calculation unit;

FIG. 14 is a flowchart showing a procedure performed by an image stabilization apparatus in a modified example;

FIG. 15 is a block diagram showing an image stabilization apparatus of applied configuration 1;

FIG. 16 is a flowchart showing a procedure performed by the image stabilization apparatus of applied configuration 1;

FIG. 17 is a diagram showing coordinate information on a representative point shown in a document layout coordinate system;

FIG. 18 is a flowchart showing a procedure for calculating a PSF estimation marker region;

FIG. 19 is a flowchart showing a procedure for generating a reference image of the PSF estimation marker;

FIG. 20 is a diagram showing the PSF estimation marker information read from the marker information keeping unit;

FIG. 21 is a diagram showing a rendering example of the reference image of the PSF estimation marker (where the marker shape is a circle);

FIG. 22 is a block diagram showing an image stabilization apparatus of applied configuration 2;

FIG. 23 is a diagram showing an exemplary configuration of a document used in applied configuration 2;

FIG. 24 is a diagram showing a process of the image stabilization apparatus of applied configuration 2;

FIG. 25 is a block diagram showing an image stabilization apparatus of applied configuration 3;

FIG. 26 is a diagram showing one-dimensional PSF data obtained by deconvolution;

FIG. 27 is a diagram showing the estimated PSF data expanded into two-dimension data;

FIG. 28 is a flowchart showing a procedure performed by the image stabilization apparatus of applied configuration 3;

FIG. 29 is a flowchart showing a procedure for calculating a position of an estimation ruler line;

FIG. 30 is a diagram showing an example of layout information read from the marker information keeping unit;

FIG. 31 is a flowchart of a procedure for calculating an estimation ruler line width;

FIG. 32 is a flowchart showing a procedure for generating a reference image of an estimation ruler line cross-section;

FIG. 33 is a diagram showing an exemplary configuration of a document used in applied configuration 4; and

FIG. 34 is a block diagram showing an image stabilization apparatus of applied configuration 4.

### DESCRIPTION OF EMBODIMENTS

Hereafter, embodiments of the present invention are explained in detail with reference to the drawings.

### 1. Principles

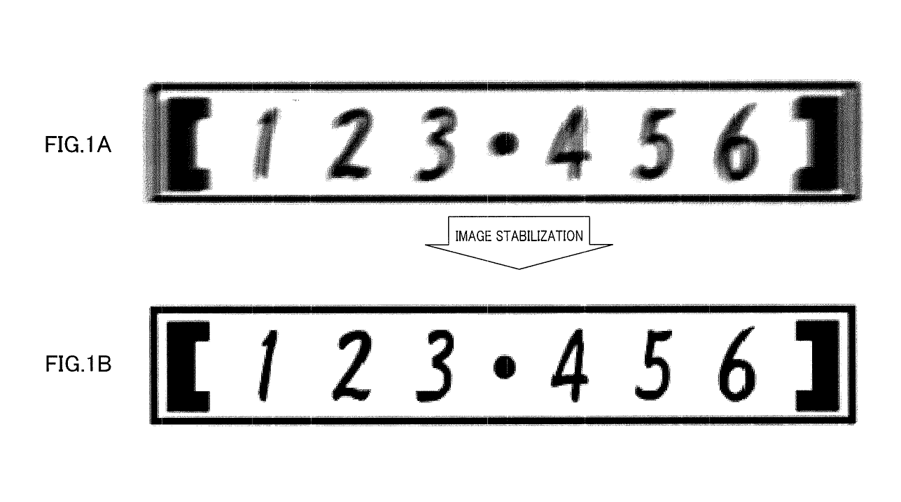

First, principles of the embodiments are explained. FIG. 1 is a diagram showing image stabilization according to the present embodiment. In the present embodiment, a sharp still image as shown in FIG. 1B is obtained from a still image having a camera shake (blurring) as shown in FIG. 1A.

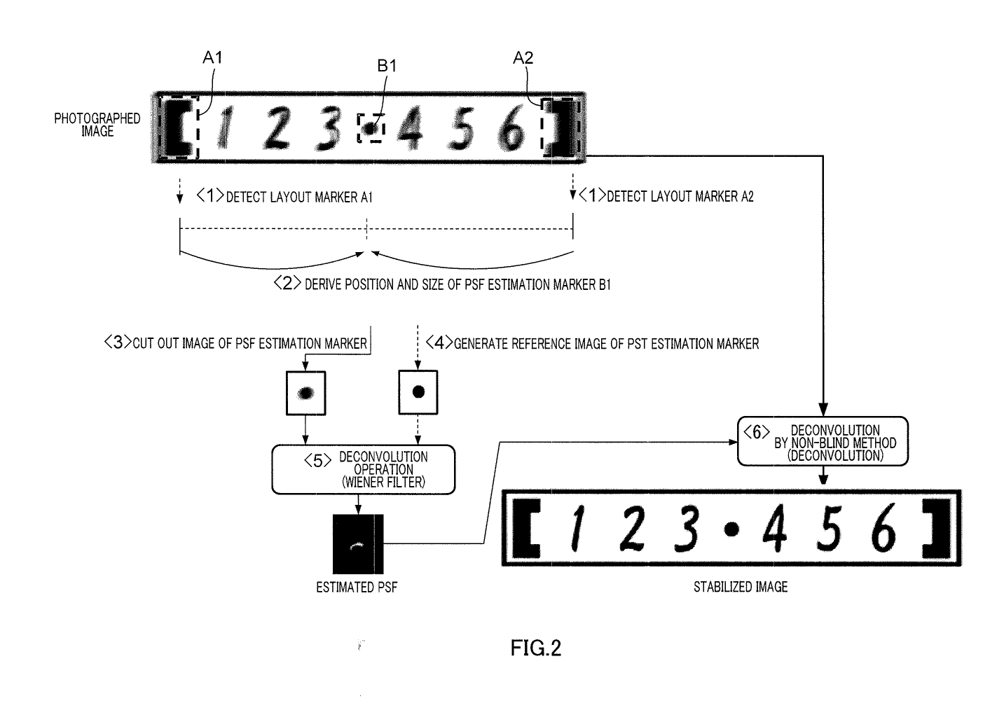

FIG. 2 is a diagram showing an overview of processing of the present embodiment. In the present embodiment, a case where a photographic subject is a document is exemplified. That is, a photographed image is an image obtained by photographing a document. However, an image stabilization target of the present embodiment is not limited to the photographed image of the document. Therefore, in the following explanation, a “document” can be read as a “reading target.”

In the present embodiment, the document is processed as follows.

Known patterns (layout markers) A1 and A2 for acquiring positional relationships within a photographed image are printed. Layout markers A1 and A2 are two markers that are spaced apart from each other. The shapes of layout markers A1 and A2 are not limited to any particular shape, but preferably have a size surely readable by a camera and also have an easily recognizable pattern.

A known pattern (PSF estimation marker) B1 for estimating a PSF is printed. The shape of PSF estimation marker B1 is not limited to a particular shape, but preferably is a closed figure such as a circle, a triangle, a quadrangle or a polygon. As will be described later, layout markers A1 and A2 or a ruler line such as a reading frame can serve as the PSF estimation marker B1.

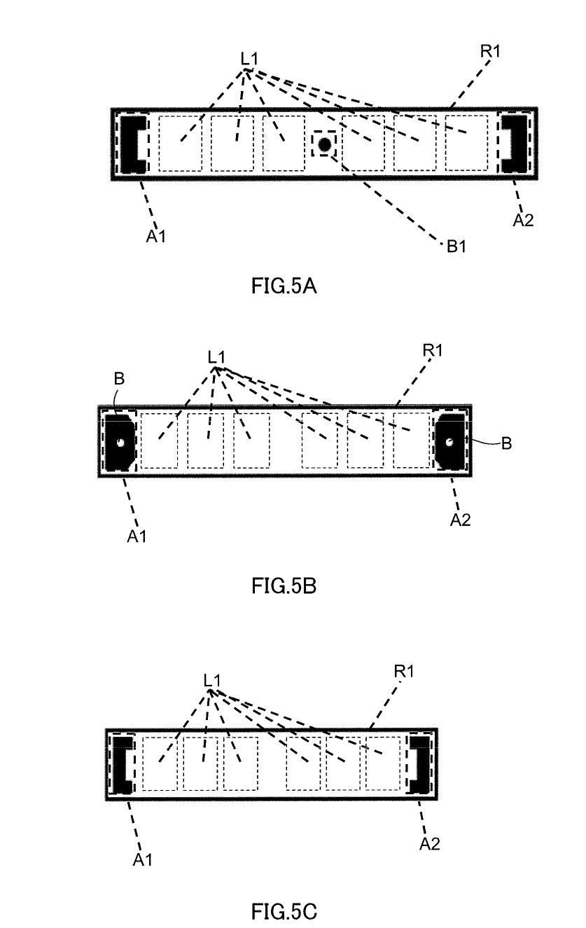

Examples of arrangement of the markers in the document will be described later in detail (FIG. 5).

Next, an overview of an image stabilization process will be described. The image stabilization process is performed in the following order.

<1> Layout markers A1 and A2 are detected in the photographed image.
<2> Based on the positions of layout markers A1 and A2, the position and size of PSF estimation marker B1 are derived. Here, it is assumed that the positional relationship and the relationship of sizes of layout markers A1 and A2 and PSF estimation marker B1 on an actual document are known in the blurring correction apparatus (that is, those pieces of information are stored in advance in the blurring correction apparatus).
<3> A subregion including PSF estimation marker B1 is cut out from the photographed image.
<4> An image having no blurring for PSF estimation marker B1 is generated based on the information derived in above-described <2>. Here, it is assumed that the shape of PSF estimation marker B1 is known in the blurring correction apparatus (that is, the information is stored in advance in the blurring correction apparatus). In the example of FIG. 2, the shape of PSF estimation marker B1 is a circle, and the information obtained in the above-described <2> is used for information on the radius of the circle.
<5> The PSF is estimated by performing a deconvolution operation by using the two marker images for PSF estimation obtained in the above-described <3>, and <4>.
<6> By performing the deconvolution operation according to Non-blind method using the estimated PSF, a stabilized image is obtained by correcting the blurring of the photographed image as a whole or the image of a region of interest.

### 2. Basic Configuration

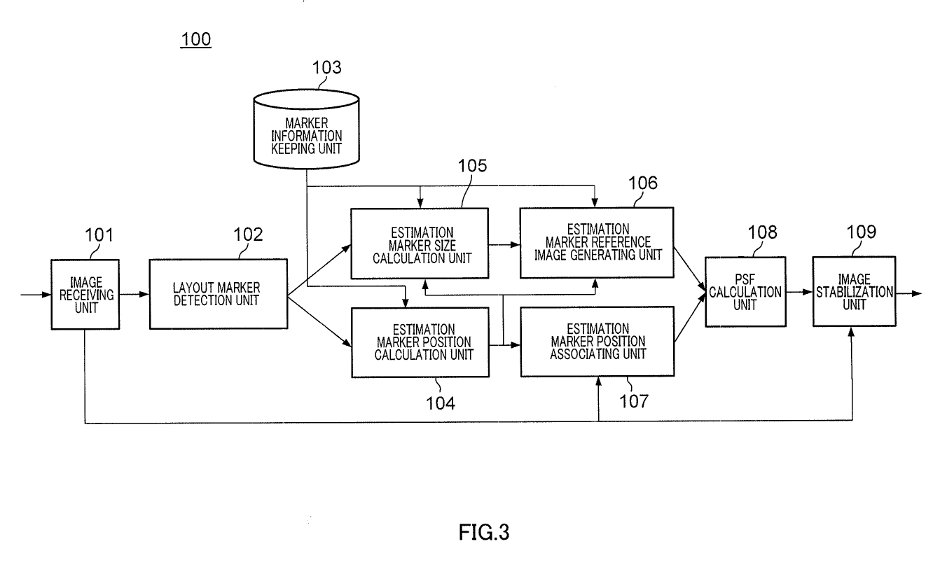

FIG. 3 shows a basic configuration of an image stabilization apparatus according to the present embodiment.

Image stabilization apparatus 100 receives an image that is a target of image stabilization by image receiving unit 101. Image receiving unit 101 has a frame memory, receives a photographed image obtained by photographing a subject, including a document or the like as shown in FIG. 1A and stores the image in frame units.

Layout marker detection unit 102 searches images stored in image receiving unit 101 for layout markers A1 and A2 whose shapes are predetermined. As a search method for layout markers A1 and A2, a publicly known method such as pattern detection may be used. Layout markers A1 and A2 in a photographed image are detected by, for example, template matching, feature point matching or the like.

Marker information keeping unit 103 keeps information on the sizes, the positional relationship, and the shape regarding layout markers A1 and A2 and PSF estimation marker (hereafter, the PSF estimation marker is called simply as an estimation marker) B.

Estimation marker position calculation unit 104 calculates a position of estimation marker B based on layout markers A1 and A2 detected by layout marker detection unit 102 and marker information kept by marker information keeping unit 103. The calculation of the estimation marker position will be described in detail later.

Estimation marker size calculation unit 105 calculates a size of estimation marker B based on layout markers A1 and A2 detected by layout marker detection unit 102, and the position of the estimation marker B calculated by estimation marker position calculation unit 104, and marker information kept in marker information keeping unit 103. The calculation of the estimation marker size will be described later in detail.

Estimation marker reference image generating unit 106 generates a reference image of estimation marker B based on the position of estimation marker B calculated by estimation marker position calculation unit 104, the size of estimation marker B calculated by estimation marker position size calculation unit 105, and the shape of estimation marker B kept in marker information keeping unit 103. The reference image generation process for estimation marker B will be described in detail later.

Estimation marker position associating unit 107, based on the position of estimation marker B calculated by estimation marker position calculation unit 104, cuts out the position of estimation marker in the photographed image while associating the positions with each other. Specifically, estimation marker position associating unit 107 cuts out a subregion image including PSF estimation marker B from a frame memory of image receiving unit 101 based on the position and size of PSF estimation marker B and keeps the subregion image as actual PSF estimation marker image data.

PSF calculation unit 108 calculates (estimates) a PSF by performing a deconvolution process by using an estimation marker reference image obtained by estimation marker reference image generating unit 106, and an estimation marker image cut out from the photographed image by estimation marker position associating unit 107. Here, in order to perform a deconvolution operation, it is possible to use an element that performs a deconvolution operation in a frequency domain, such as an inverse filter or a Wiener filter.

Image stabilization unit 109 performs a deconvolution operation on the whole of the photographed image stored in the frame memory of image receiving unit 101 or a region of interest of the image data to correct the blurring in the photographed image by using the estimated PSF data obtained by PSF calculation unit 108. The deconvolution operation here may be performed by using, for example, an inverse filter or a Wiener filter that performs deconvolution operation in a frequency domain. However, the method for deconvolution is not limited to this, and any method that can perform Non-blind Deconvolution can be used. Image stabilization unit 109 stores image data in which blurring is corrected in an image output memory, or records the image data in an external storage medium.

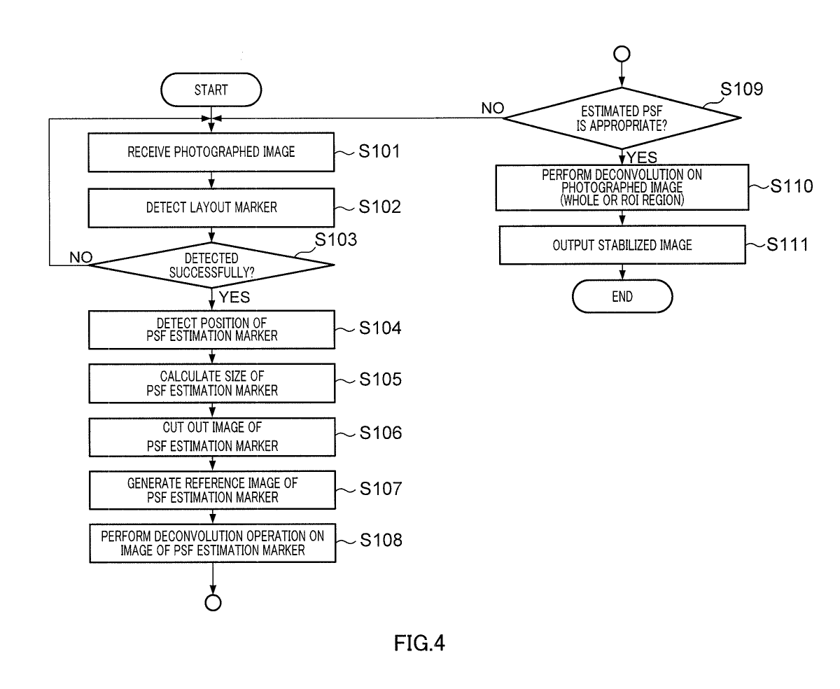

FIG. 4 shows a procedure performed by the image stabilization apparatus 100.

Upon start of an image stabilization process, image stabilization apparatus 100 receives a photographed image by image receiving unit 101 in step S101. In step S102 following step S101, layout marker detection unit 102 detects layout markers A1 and A2, and it is determined in step S103 whether the layout markers A1 and A2 are detected successfully. For example, when the positions where at least two layout markers A1 and A2 exist (coordinates within the image) are successfully obtained, the detection is determined to be successful and otherwise the detection is determined to be failed. In step S103, when the detection is determined to be successful, the process proceeds to step S104.

In step S104, estimation marker position calculation unit 104 calculates the position of PSF estimation marker B. In step S105, estimation marker size calculation unit 105 calculates the size of PSF estimation marker B.

In step S106, estimation marker position associating unit 107 cuts out the image of PSF estimation marker from the photographed image. In step S107, estimation marker reference image generating unit 106 generates a reference image of PSF estimation marker B. In step S108, PSF calculation unit 108 performs a deconvolution operation of the image of the PSF estimation marker to obtain estimated PSF data.

In step S109, PSF calculation unit 108 determines whether the estimated PSF thus calculated is appropriate for use in the image stabilization. As examples of decision criteria (criteria for determining that the estimated PSF is appropriate for use in the image stabilization), the following two criteria can be cited. One criterion is that the number of elements whose signal level is high of the estimated PSF data is the predetermined number or less. Another criterion is that when the estimated PSF data is viewed as a two-dimensional image, there are no independent, multiple domains where the signal level is high. When the estimated PSF is determined to be appropriate in step S109 (step S109; Yes), the processing proceeds to step S110, while processing returns to step S101 when the estimated PSF is determined to be not appropriate (step S109; No).

In step S110, image stabilization unit 109 performs a deconvolution operation on the photographed image (on the whole of the image or the ROI (Region Of Interest)) by using the PSF obtained in step S109 to thereby correct the blurring in the photographed image.

In step S111, image stabilization unit 109 outputs an image after image stabilization to another apparatus, such as a document control apparatus or a monitor.

### 2-1. Configuration of Document

FIG. 5 shows an exemplary configuration of a document of the present embodiment. Here, three examples as shown in FIG. 5A, FIG. 5B and FIG. 5C will be described.

First, a document in FIG. 5A is described. The example of FIG. 5A is one example in which layout markers A1 and A2 and PSF estimation marker B1 are independent from one another. The document shown in FIG. 5A is the same as the document described also in FIG. 1 and FIG. 2. Reading frame R1 is printed on the document. Reading frame R1 shows that the region surrounded thereby is a reading target. In general, a camera reads (photographs) the region within reading frame R1 with reference to reading frame R1. In reading frame R1, character entry area L1, layout markers A1 and A2, and PSF estimation marker B1 are printed. Character entry area L1 includes six cells in the example of the drawing, and numeric characters or the like are entered in the respective cells. Layout markers A1 and A2 are provided on the positions located across character entry area L1. Layout marker A1 is the start position, and layout marker A2 is the termination position. PSF estimation marker B1 is printed on a substantially center position in reading frame R1. As described above, it is preferable that the shape of PSF estimation marker B1 be a closed figure such as a circle, a triangle, a quadrangle or a polygon.

The example shown in FIG. 5B is an example where layout markers A1 and A2 also serve as PSF estimation marker B1. The white circles on centers in layout markers A1 and A2 each correspond to PSF estimation marker B.

The example shown in FIG. 5C is an example where there is no PSF estimation marker B. When such a document is used, a ruler line is utilized for PSF estimation. Specifically, the image stabilization apparatus performs PSF estimation by using any of ruler lines on the four sides of read reading frame R1. Such a method for PSF estimation will be described later in detail.

### 2-2. Process for Calculating PSF Estimation Marker Position

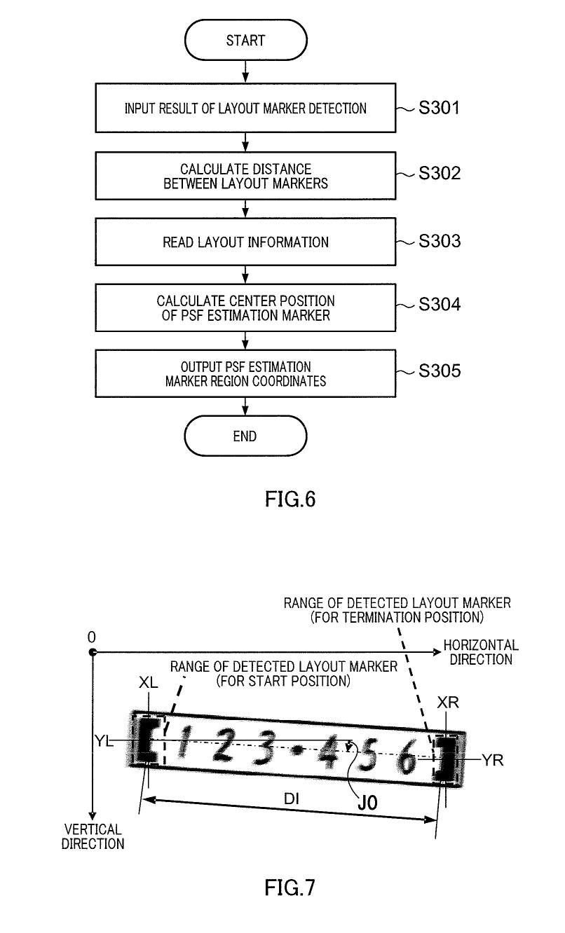

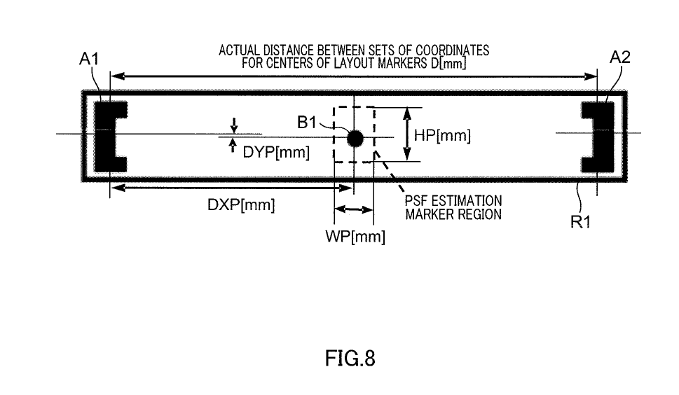

An explanation is given in detail by using FIG. 6, FIG. 7 and FIG. 8 of a process for calculating the PSF estimation marker position performed by estimation marker position calculation unit 104. FIG. 6 is a flowchart showing a procedure performed by estimation marker position calculation unit 104. FIG. 7 is a diagram for explaining a distance between the layout markers calculated based on the photographed image. FIG. 8 is a diagram showing the layout information of the document read from marker information keeping unit 103. FIG. 7 and FIG. 8 are diagrams regarding the case where the format of the document is that shown in FIG. 5A.

Estimation marker position calculation unit 104, as shown in FIG. 6, first, receives a result of layout marker detection from layout marker detection unit 102 in step S301. Specifically, estimation marker position calculation unit 104 receives a set of coordinates of a center of layout marker A1 for the start position and a set of coordinates of a center of layout marker A2 for the termination position.

In step S302, estimation marker position calculation unit 104 calculates a distance between layout markers A1 and A2. More specifically, estimation marker position calculation unit 104 calculates distance DI in the image and between the two sets of coordinates of the centers received as shown in FIG. 7 in accordance with the following formula.

(Equation 1)

DI=sqrt((XR−XL)²+(YR−YL)²) [1]

Here, (XL, YL) is the set of coordinates of the center of layout marker A1 for the start position, and (XR, YR) is the set of coordinates of the center of layout marker A2 for the termination position.

In step S303, estimation marker position calculation unit 104 reads and acquires layout information as shown in FIG. 8 from marker information keeping unit 103. The information acquired by estimation marker position calculation unit 104 is the following information.
Actual distance D between layout markers A1 and A2 on a document sheet surface
Relative position (DXP, DYP) of the center of the PSF estimation marker range with the center position of the layout marker as the reference
Actual size (WP, HP) of the PSF estimation marker region

In step S304, estimation marker position calculation unit 104 calculates a center position of PSF estimation marker B 1. Specifically, assuming that the set of center position coordinates is denoted as (XP, YP), estimation marker position calculation unit 104 calculates (XP, YP) according to the following formula by using a similarity relationship between the photographed image and the document layout.

(Equation 2)

XP=XL+cos R0·DXP·Z−sin R0·DYP·Z

YP=YL+sin J0·DXP·Z+cos J0·DYP·Z [2]

where

R0: an angle formed by a line segment connecting between the centers of the layout markers with a horizontal axis; J0=tan⁻¹((YR−YL)/(XR−XL)); and Z=DI/D.

In step S305, estimation marker position calculation unit 104 calculates and outputs a set of PSF estimation marker region coordinates. Specifically, when a set of upper left coordinates and a set of lower right coordinates of the region to be calculated are respectively (XPL, YPT), (XPR, YPB), estimation marker position calculation unit 104 calculates the set of upper left coordinates (XPL, YPT) and the set of lower right coordinates (XPR, YPB) by using the actual size of the PSF estimation marker region acquired in step S303 and the result of calculation in step S304 according to the following formula and outputs the region coordinate data.

(Equation 3)

XPL=XP−((WP/2)·cos J0+(HP/2)·sin |J0|)·Z

YPT=YP−((WP/2)·sin |J0|+(HP/2)·cos J0)·Z

XPR=XP+((WP/2)·cos J0+(HP/2)·sin |J0|)·Z

YPB=YP+((WP/2)·sin |J0|+(HP/2)·cos J0)·Z [3]

### 2-3. Process for Calculating Size of PSF Estimation Marker

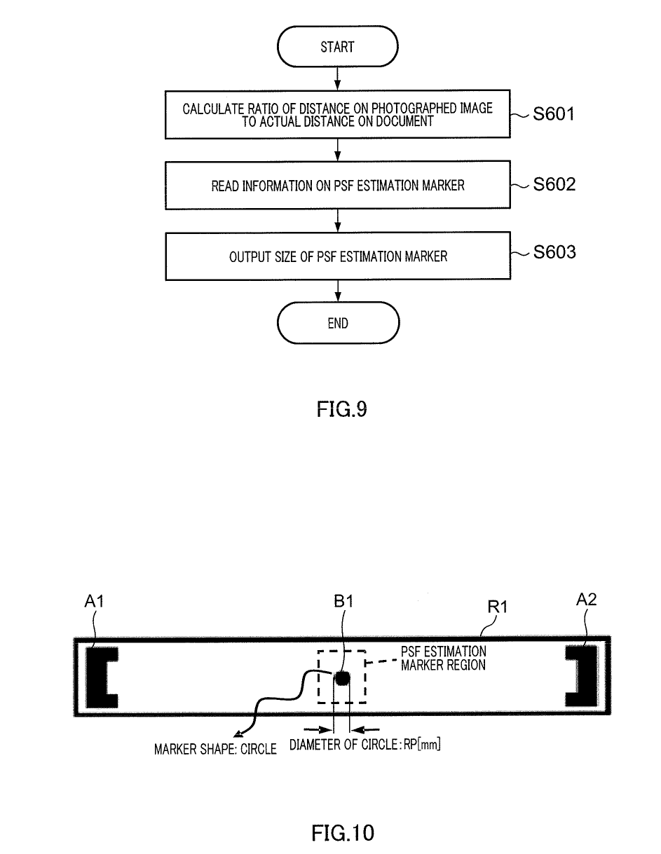

An explanation is given in detail by using FIG. 9 and FIG. 10 of a process for calculating the size of PSF estimation marker B performed by estimation marker size calculation unit 105. FIG. 9 is a flowchart showing a procedure performed by estimation marker size calculation unit 105. FIG. 10 is a diagram for explaining the PSF estimation marker information read from marker information keeping unit 103.

As shown in FIG. 9, first, in step S601, estimation marker size calculation unit 105 calculates ratio Z of distance DI (FIG. 7) between the layout markers A1 and A2 on the photographed image to the actual distance D (FIG. 8) between the layout markers A1 and A2 on the document. Since distances DI and D are also calculated by estimation marker position calculation unit 104, estimation marker size calculation unit 105 obtains ratio Z by receiving distances DI and D from estimation marker position calculation unit 104.

In step S602, estimation marker size calculation unit 105 reads and acquires information on PSF estimation marker B1 on the document from marker information keeping unit 103. The information acquired by estimation marker size calculation unit 105 is the following information (see FIG. 10).
Shape and value of actual size of marker B (diameter RP where the shape is a circle).

In step S603, estimation marker size calculation unit 105 calculates the size of the PSF estimation marker on the photographed image by using ratio Z calculated in step S601 and the value of actual size acquired in step S602 and outputs a calculation result. Here, the PSF estimation marker size to be calculated is marker size RPI=RP*Z where the shape is a circle.

### 2-4. Process for Generating Reference Image of PSF Estimation Marker

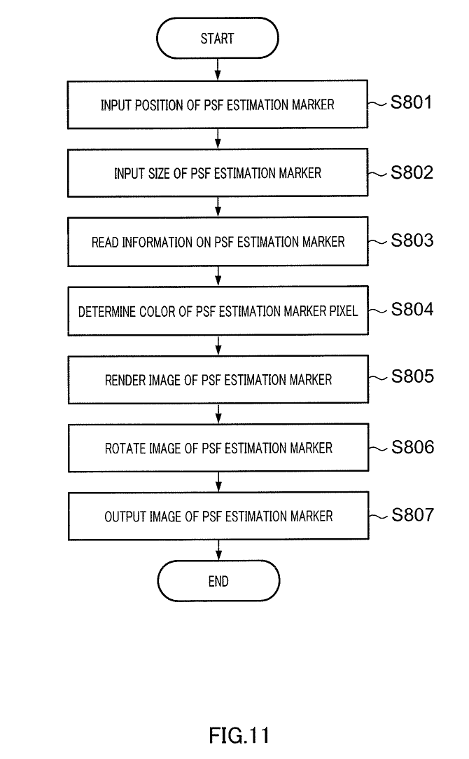

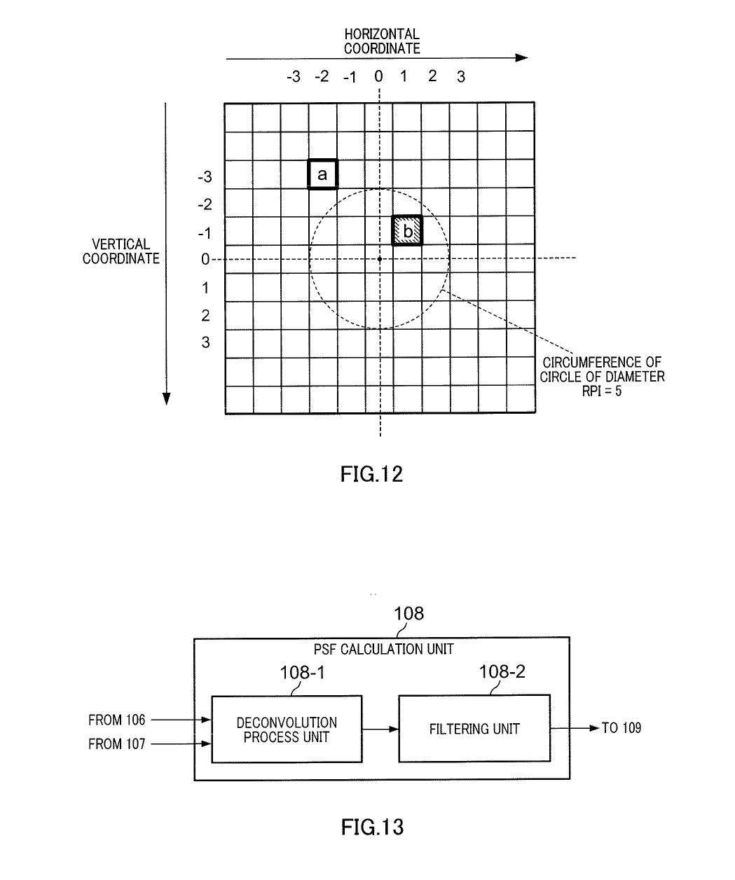

An explanation is given in detail by using FIG. 11 and FIG. 12 of a process for generating the reference image of the PSF estimation marker performed by estimation marker reference image generating unit 106. FIG. 11 is a flowchart showing a procedure performed by estimation marker reference image generating unit 106. FIG. 12 is a diagram showing an example of rendering the reference image (where the marker shape is a circle) of the PSF estimation marker.

Estimation marker reference image generating unit 106, as shown in FIG. 11, first, in step S801 receives the position of PSF estimation marker B from estimation marker position calculation unit 104. Specifically, estimation marker reference image generating unit 106 receives a set of PSF estimation marker region coordinates. The set of PSF estimation marker region coordinates is, as described above, for example when the rectangle region is represented, a set of upper left coordinates (XPL, YPT) and a set of lower right coordinates (XPR, YPB).

In step S802, estimation marker reference image generating unit 106 receives the size of PSF estimation marker B from estimation marker size calculation unit 105. Specifically, estimation marker reference image generating unit 106 receives the PSF estimation marker size and an angle of deviation J0(FIG. 7).

In step S803, estimation marker reference image generating unit 106 reads and acquires information on PSF estimation marker B on the document from marker information keeping unit 103. The information acquired by estimation marker reference image generating unit 106 is the following information.
The shape and color arrangement of marker B (black on the white background or white on the black background)

In step S804, estimation marker reference image generating unit 106 determines a color of a PSF estimation marker pixel. Specifically, a pixel value in the range input and specified in step S801 is read from the frame memory (image receiving unit 101) in which the photographed image is stored, and the pixel color of PSF estimation marker B is determined.

As a method for determination, there are two examples in the following.

### Example 1

A histogram of pixel values within the range is set, and a pixel level that is a peak in each of a low luminance side and a high luminance side is extracted, and a pixel value forming the peak in the low luminance side is assigned to black color of the PSF estimation marker, and a pixel value forming the peak in the high luminance side is assigned to the white color of the PSF estimation marker.

### Example 2

A minimum value of the pixel values within the range is assigned to the black color of the PSF estimation marker, and a maximum value of the pixel values within the range is assigned to the white color of the PSF estimation marker.

In step S805, estimation marker reference image generating unit 106 renders an image of the PSF estimation marker. Specifically, estimation marker reference image generating unit 106 calculates a size of the region from the set of marker region coordinates input in step S801, and prepares an image memory having a size that is the same as the size of the region. Then, estimation marker reference image generating unit 106 renders a pattern of the PSF estimation marker in the prepared image memory based on the information obtained in step S802 and step S803. For the pixel value corresponding to each of the white and black of the patterns, a pixel value determined in step S804 is used.

FIG. 12 shows the example of rendering. FIG. 12 is a diagram showing the example of rendering a reference image of the PSF estimation marker (where the marker shape is a circle). In FIG. 12, rendering is performed by performing the determination as described below on pixel a and pixel b.

For pixel a, it is determined that the pixel is outside of the circumference according to (x-coordinate)²+(y-coordinate)²=13>(RPI/2)²=6.25 and rendered by a background color. For pixel b, it is determined that the pixel is inside of the circumference according to (x-coordinate)²+(y-coordinate)²=2<(RPI/2)²=6.25 and rendered by a foreground color.

By performing the same determination processing also for other pixels, it is determined by which of the background and foreground colors the pixel is to be rendered, to perform rendering. Here, in the case of marker color arrangement in which the maker is black on the white background, the background color is “white” and foreground color is “black.” Inversely, in the case of marker color arrangement in which the marker is white on the black background, the background color is “black” and the foreground color is “white.” Specific pixel values for “white” and “black” are the values determined in step S804.

In step S806, estimation marker reference image generating unit 106 rotates the image of the PSF estimation marker. Specifically, rotational conversion by rotational angle J0 (FIG. 7) is performed on the image data rendered in step S805. Here, the center of rotation may be a set of coordinates of the center of the image of the PSF estimation marker rendered. When the shape of the marker is a circle, this step may be omitted.

In step S807, estimation marker reference image generating unit 106 outputs data in the image memory on which the processes of steps S805 to S806 are performed, as a PSF estimation marker reference image.

### 2-5. Modified Example

It is possible to obtain a clearer image when PSF calculation unit 108 is configured as shown in FIG. 13, and filtering is performed by a filtering unit 108-2 on the estimated PSF data calculated in a deconvolution process unit 108-1. That is, this makes it possible to obtain a clear estimated PSF even when an SN (Signal to Noise ratio) of the photographed image is low or when there is an error in the PSF estimation marker reference image, and improve the picture quality after image stabilization. As filtering unit 108-2, it is possible to use an LPF (Low Pass Filter) or a median filter or those filters which eliminate high frequency components or an impulse-like noise.

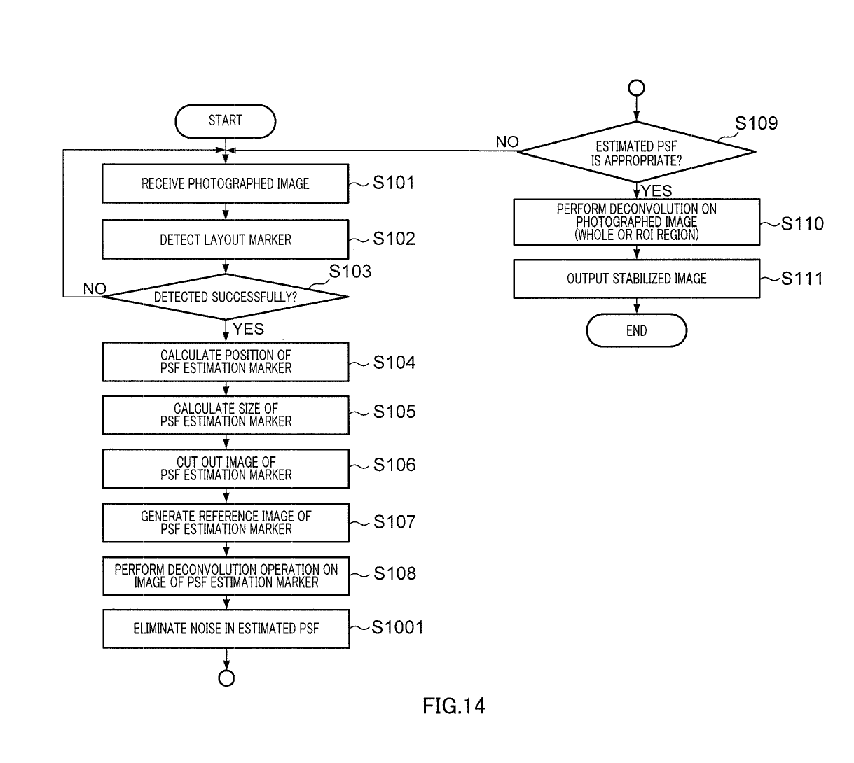

FIG. 14 shows a procedure of this modified example. In FIG. 14, same reference signs as FIG. 4 are applied to the processes that are the same as those in FIG. 4. The point where the procedure in FIG. 14 is different from the procedure in FIG. 4 is that, in step S 1001, filtering unit 108-2 performs filtering in order to eliminate the estimation noise component from the estimated PSF data obtained in step S 108.

### 3. Applied Configuration 1

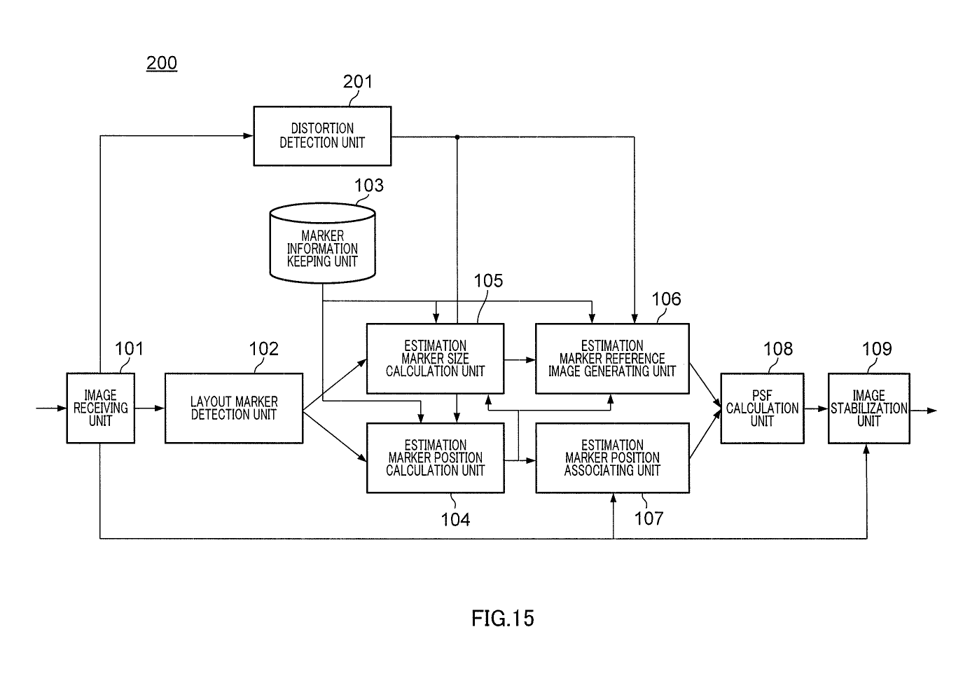

FIG. 15 shows applied configuration 1. In FIG. 15, same reference signs as FIG. 3 are applied to the components that are the same as those in FIG. 3. A difference of image stabilization apparatus 200 in FIG. 15 from image stabilization apparatus 100 of FIG. 3 is that image stabilization apparatus 200 has distortion detection unit 201. Distortion detection unit 201 detects distortion in a photographed image caused by the fact that an imaging plane of the camera and a sheet are not in parallel. Distortion detection unit 201 outputs a result of detection to estimation marker reference image generating unit 106 and estimation marker position calculation unit 104. Estimation marker reference image generating unit 106 generates a reference image of the estimation marker also in consideration of distortion.

Here, it is often that in the case where a document is photographed by a hand-held camera or the like, a sheet surface of the document is not perpendicular to an optical axis of the camera. In this case, the marker is photographed while being geometrically deformed in shape. Then, image stabilization apparatus 200 detects the geometrical deformation of the marker shape by distortion detection unit 201 and performs PSF estimation after deforming the PSF estimation marker reference image in the same way. This makes it possible to suppress the enlargement of estimation error. Image stabilization apparatus 200 is configured to add the same distortion as that in the photographed image to the PSF estimation marker reference image without correcting the distortion of the photographed image, rather than performing a series of processes for the basic configuration (FIG. 3) after correcting geometric distortion in the photographed image (input image).

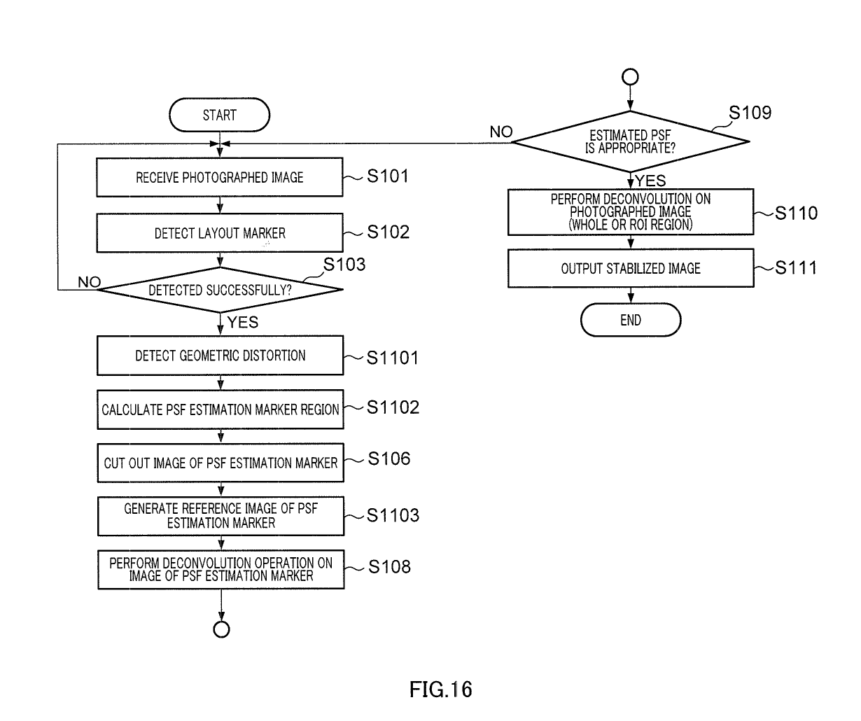

FIG. 16 shows a procedure performed in image stabilization apparatus 200. In FIG. 16, same reference signs as FIG. 4 are applied to the processes that are same as those in FIG. 4. The point where the procedure of FIG. 16 is different from the procedure of FIG. 4 is, mainly, a geometric distortion detection process in step S1101, a PSF estimation marker region calculation process in step S1102, and a PSF estimation marker reference image generation process in step S 1103. Hereafter, these processes are described in detail.

### 3-1. Process for Detecting Geometric Distortion

An explanation is given of a process for detecting geometric distortion performed in step S1101 by distortion detection unit 201.

Distortion detection unit 201 detects a planar distortion on the image of document sheet surface received in step S101; and obtains homography matrix H that represents the distortion. Homography matrix H is formed of 3×3 elements and includes eight unknown numeric elements and can be represented by the following formula:

$$[ 4 ]$$

$$[ \begin{matrix}h 1 & h 2 & h 3 \\ h 4 & h 5 & h 6 \\ h 7 & h 8 & 1\end{matrix} ] \qquad ( Equation 4 )$$

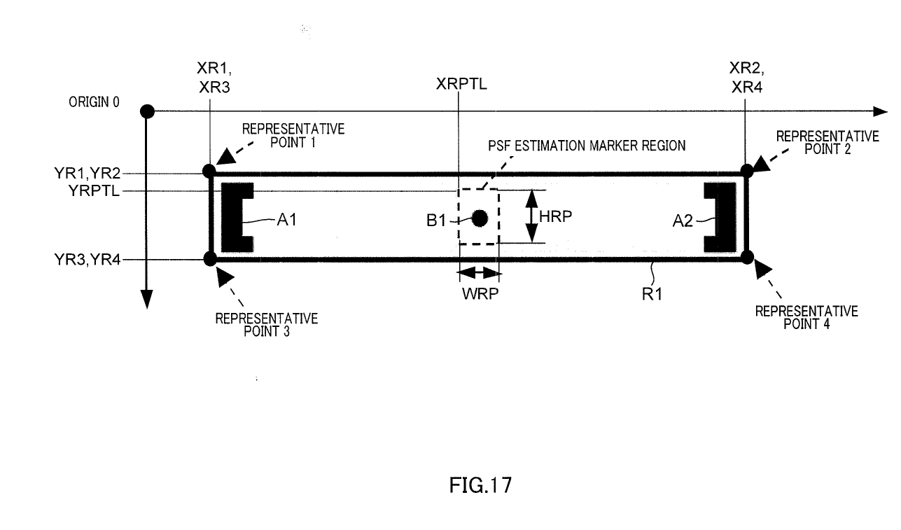

As a method for calculating H, there is a method that detects which sets of coordinates in the photographed image the four representative points on the document as shown in FIG. 17 (these sets of coordinates are already-known as the sets of coordinates represented on the coordinate system on the document layout) are observed, and assigns the values of the known sets of coordinates and the sets of observation coordinates to the following formula to derive each element of H.

$$[ 5 ]$$

$$[ \begin{matrix}XRn & YRn & 1 & 0 & 0 & 0 & - XRn \cdot XIn & - YRn \cdot XIn \\ 0 & 0 & 0 & XRn & YRn & 1 & - XRn \cdot YIn & - YRn \cdot YIn\end{matrix} ] [ \begin{matrix}h 1 \\ h 2 \\ \cdot \\ \cdot \\ \cdot \\ h 8\end{matrix} ] = [ \begin{matrix}XIn \\ YIn\end{matrix} ] \\ ( n = 1 , 2 , 3 , 4 ) \qquad ( Equation 5 )$$

Here, (XRn, YRn) represents a set of known coordinates of n-th representative point (expressed by document layout coordinate system), and (XIn, YIn) represents a set of observation coordinates of the n-th representative point (expressed by photographed image coordinate system).

FIG. 17 is a diagram showing coordinate information on the representative points represented by the document layout coordinate system. As a method for detecting the representative point coordinates within the photographed image, the following method may be used.

Method 1) When four corner points of reading frame R1 of the document are set to be the representative points, edges are detected from the image and coordinates of intersection points of the detected edges are calculated to thereby obtain the representative point coordinates.

Method 2) A document image having no distortion is generated, and feature point matching with the photographed image is performed. Of a plurality of matched coordinate pairs, four points whose evaluation values are high are extracted.

### 3-2. Process for Calculating PSF Estimation Marker Region

An explanation is given of a process for calculating a PSF estimation marker region performed in step S1102 by estimation marker position calculation unit 104.

Estimation marker position calculation unit 104 calculates a PSF estimation marker region by using the document layout information from marker information keeping unit 103, and the homography matrix calculated in step S1101.

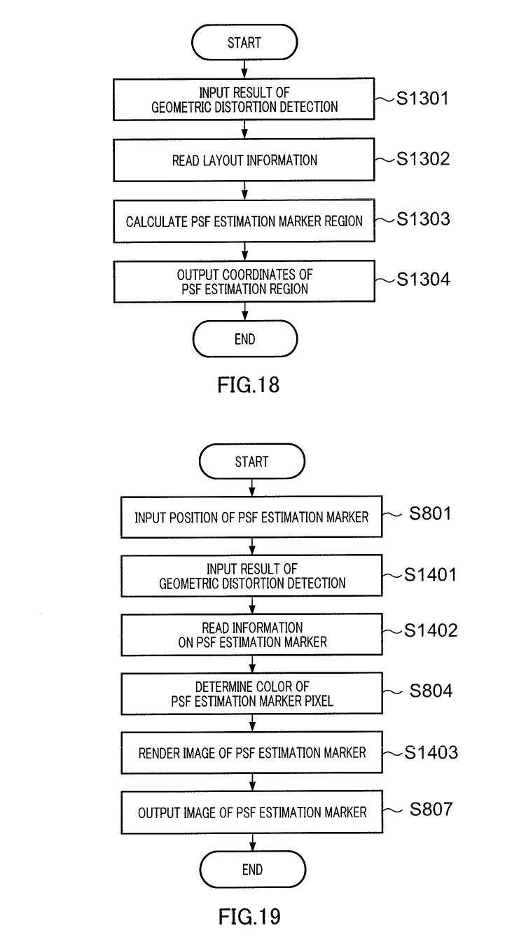

FIG. 18 is a flowchart showing a procedure for calculating a PSF estimation marker region (that is, a flowchart showing the details of the content of the process in step S 1102).

Estimation marker position calculation unit 104 receives homography matrix H from distortion detection unit 201 in step S1301. In step S1302, estimation marker position calculation unit 104 reads out layout information of document from marker information keeping unit 103 and obtains sets of coordinates of the PSF estimation marker region. In the case of the example of FIG. 17, the set of coordinates (XRPTL, YRPTL) of the upper left corner and the width WRP and the height HRP of the region are obtained as the coordinates of the PSF estimation marker region.

In step S1303, estimation marker position calculation unit 104 calculates a PSF estimation marker region. Specifically, the sets of coordinates of four corners of the PSF estimation marker region are respectively transformed into sets of coordinates in the photographed image coordinate system according to homography matrix H. In the case of the example of FIG. 17, when the sets of coordinates after transformation of the points of the top left corner, the top right corner, the bottom left corner and the bottom right corner are denoted as (XIP1, YIP1), (XIP2, YIP2), (XIP3, YIP3), (XIP4, YIP4), respectively, these coordinates can be obtained according to the following transformation formula.

$$[ 6 ] \\ [ \begin{matrix}XIP 1 \\ YIP 1 \\ 1\end{matrix} ] = w 1 [ \begin{matrix}h 1 & h 2 & h 3 \\ h 4 & h 5 & h 6 \\ h 7 & h 8 & 0\end{matrix} ] [ \begin{matrix}XRPTL \\ YRPTL \\ 1\end{matrix} ] \\ [ \begin{matrix}XIP 2 \\ YIP 2 \\ 1\end{matrix} ] = w 2 [ \begin{matrix}h 1 & h 2 & h 3 \\ h 4 & h 5 & h 6 \\ h 7 & h 8 & 0\end{matrix} ] [ \begin{matrix}XRPTL + WRP \\ YRPTL \\ 1\end{matrix} ] \\ [ \begin{matrix}XIP 3 \\ YIP 3 \\ 1\end{matrix} ] = w 3 [ \begin{matrix}h 1 & h 2 & h 3 \\ h 4 & h 5 & h 6 \\ h 7 & h 8 & 0\end{matrix} ] [ \begin{matrix}XRPTL \\ YRPTL + HRP \\ 1\end{matrix} ]$$

$$[ \begin{matrix}XIP 4 \\ YIP 4 \\ 1\end{matrix} ] = w 4 [ \begin{matrix}h 1 & h 2 & h 3 \\ h 4 & h 5 & h 6 \\ h 7 & h 8 & 0\end{matrix} ] [ \begin{matrix}XRPTL + WRP \\ YRPTL + HRP \\ 1\end{matrix} ] \qquad ( Equation 6 )$$

Here, wi (i=1 to 4) is an inverse number of the value of the element in the third row of the multiplication result of the matrix in the right side of the each formula.

In step S1304, estimation marker position calculation unit 104 calculates the sets of coordinates of a rectangle region circumscribed by a rectangle defined by four points obtained by transformation in step S1303 and outputs the calculation result as PSF estimation marker region coordinates. In the case of the example of FIG. 17, when the set of top-left corner coordinates of the rectangle region to be obtained is (XPL, YPT), and the set of bottom right corner coordinate is (XPR, YPB), these sets of coordinates can be obtained by the following formula:

(Equation 7)

XPL=Min{XIP1,XIP2,XIP3,XIP4}

XPR=Max{XIP1,XIP2,XIP3,XIP4}

YPT=Min{YIP1,YIP2,YIP3,YIP4}

YPB=Max{YIP1,YIP2,YIP3,YIP4} [7]

### 3-3. Process for Generating Reference Image of PSF Estimation Marker

An explanation is given of a process for generating a reference image of the PSF estimation marker performed by estimation marker reference image generating unit 106 in step S1103.

Estimation marker reference image generating unit 106 generates a reference image of a PSF estimation marker having a distortion that is the same as that of the photographed image based on the PSF estimation marker region calculated by estimation marker position calculation unit 104, known PSF estimation marker shape data read from marker information keeping unit 103 and homography matrix H calculated in distortion detection unit 201, and keeps the reference image as PSF estimation marker reference image data.

FIG. 19 is a flowchart showing a procedure for generating a reference image of a PSF estimation marker (that is, a flowchart showing the detailed process content in step S1103). In FIG. 19, same reference signs as FIG. 11 are applied to the processes that are same as those in FIG. 11, and the explanation for the same processes are omitted hereafter.

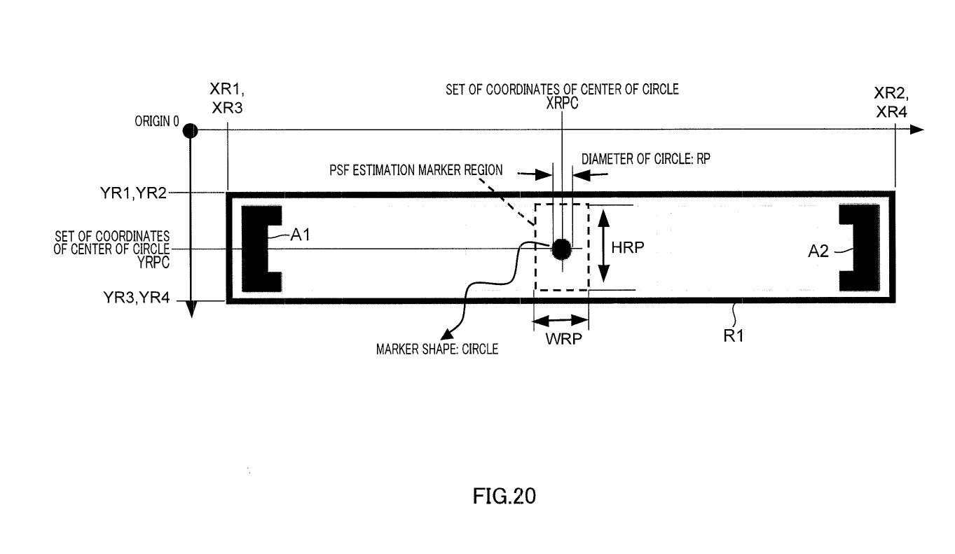

Estimation marker reference image generating unit 106 receives homography matrix H from distortion detection unit 201 in step S1401. In step S1402, estimation marker reference image generating unit 106 reads and acquires information on the PSF estimation marker on the document from marker information keeping unit 103. The information acquired by estimation marker reference image generating unit 106 is the following information:
the shape and color arrangement of the marker (black on the white background or white on the black background)
information on a marker position and a size in the document layout coordinate system (see FIG. 20).

FIG. 20 shows PSF estimation marker information to be read from marker information keeping unit 103. In the example of the drawing, the set of coordinates of the center of the marker is (XRPC, YRPC), and the diameter of the circle of the marker is RP.

In step S1403, estimation marker reference image generating unit 106 renders an image of the PSF estimation marker. Specifically, estimation marker reference image generating unit 106 calculates the size of the region from the marker region coordinates input in step S801, and prepares an image memory having the same size as the region. Then, estimation marker reference image generating unit 106 renders the pattern of the PSF estimation marker in the prepared image memory, based on the information obtained in steps S1401 and S 1402. For the pixel value corresponding to the pattern of each of white and black, each pixel value determined in step S804 is used.

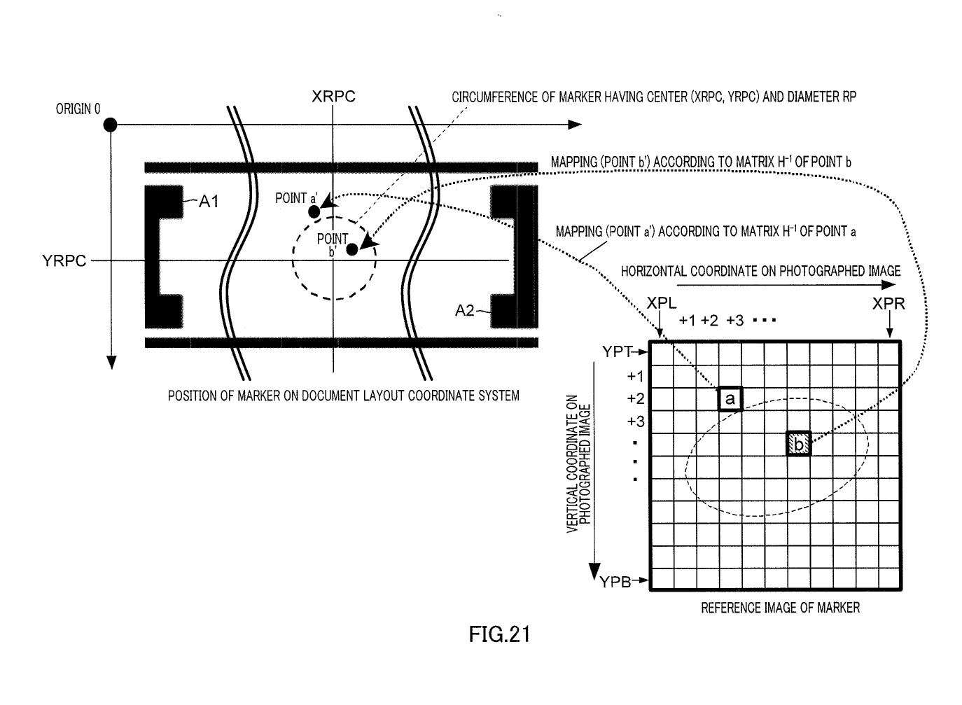

FIG. 21 shows the example of rendering. FIG. 21 is a diagram showing the example of rendering a reference image (where the marker shape is a circle) of the PSF estimation marker.

Here, to determine which of the black and white each pixel on the image memory is, it may be checked to which position of the PSF estimation marker the coordinate values obtained by mapping the coordinates of the pixel (represented in the photographed image coordinate system) on the document layout coordinate system by an inverse matrix H⁻¹ of homography matrix H correspond.

In the case of the example in FIG. 21, when the set of coordinates of pixel M on the photographed image coordinate system on the image memory is denoted as (XIM, YIM), the set of coordinates (XRM, YRM) of point M′ on the document layout coordinate system, which is obtained from the pixel M mapped by H⁻¹, is represented by the following formula:

$$[ 8 ]$$

$$[ \begin{matrix}XRM \\ YRM \\ 1\end{matrix} ] = {w [ \begin{matrix}h 1 & h 2 & h 3 \\ h 4 & h 5 & h 6 \\ h 7 & h 8 & 1\end{matrix} ]}^{- 1} [ \begin{matrix}XIM \\ YIM \\ 1\end{matrix} ] \qquad ( Equation 8 )$$

Here, w is a normalization constant that matches elements on both sides of the third row.

Distance DM between the point M′ and the center (XRPC, YRPC) of the marker circle can be calculated based on the following formula:

(Equation 9)

DM=sqrt((XRM−XRPC)²+(YRM−YRPC)²) [9]

Therefore, estimation marker reference image generating unit 106 performs determination as described below on pixel a and pixel b in FIG. 21 to perform rendering.

Pixel a comes under the case where DM>RP/2, and since point M′ is outside of the marker circle, point M is rendered in the background color. Pixel b comes under the case where DM<=RP/2, and since point M′ is inside of the marker circle, point M is rendered by the foreground color.

In this way, the estimation marker reference image generating unit can reflect the distortion detected by distortion detection unit 201 on the image of the PSF estimation marker to be the reference.

### 4. Applied Configuration 2

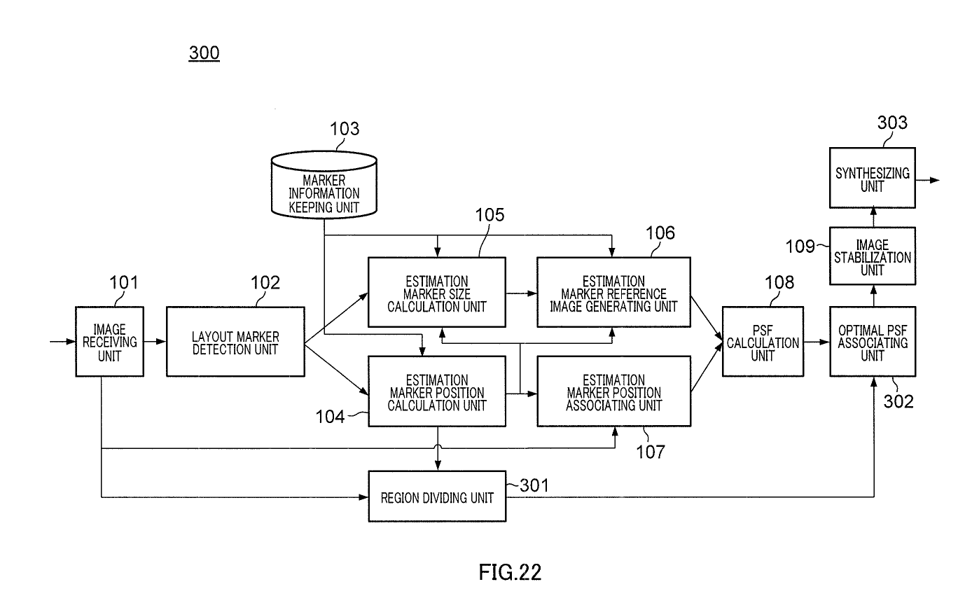

FIG. 22 shows applied configuration 2. In FIG. 22, same reference signs as FIG. 3 are applied to the components that are same as those in FIG. 3. The point where image stabilization apparatus 300 of FIG. 22 is different from image stabilization apparatus 100 in FIG. 3 is that image stabilization apparatus 300 has a region dividing unit 301, an optimal PSF associating unit 302 and a synthesizing unit 303.

Region dividing unit 301 divides a photographing region according to the position of estimation marker B in the image obtained by estimation marker position calculation unit 104. For example, a Volonoi region is prepared based on the position of each estimation marker B. Divided photographed images are output to optimal PSF associating unit 302.

Optimal PSF associating unit 302 associates PSFs corresponding to divided images. Image stabilization unit 109 performs image stabilization of each region by using the PSF corresponding to the region. Synthesizing unit 303 synthesizes the regions in which image stabilization is performed.

Here, in the case of camera shake, the whole of the screen should blur uniformly. However, depending on the conditions of photographing, the image may blur partially differently. Therefore, in the present configuration, the PSF estimation marker is formed (printed) on a plurality of locations in the document, and PSF estimation and image stabilization are performed for each location. Then, finally, selection or synthetic output of a stabilized image is performed depending on to which maker and by which degree each pixel position is close to.

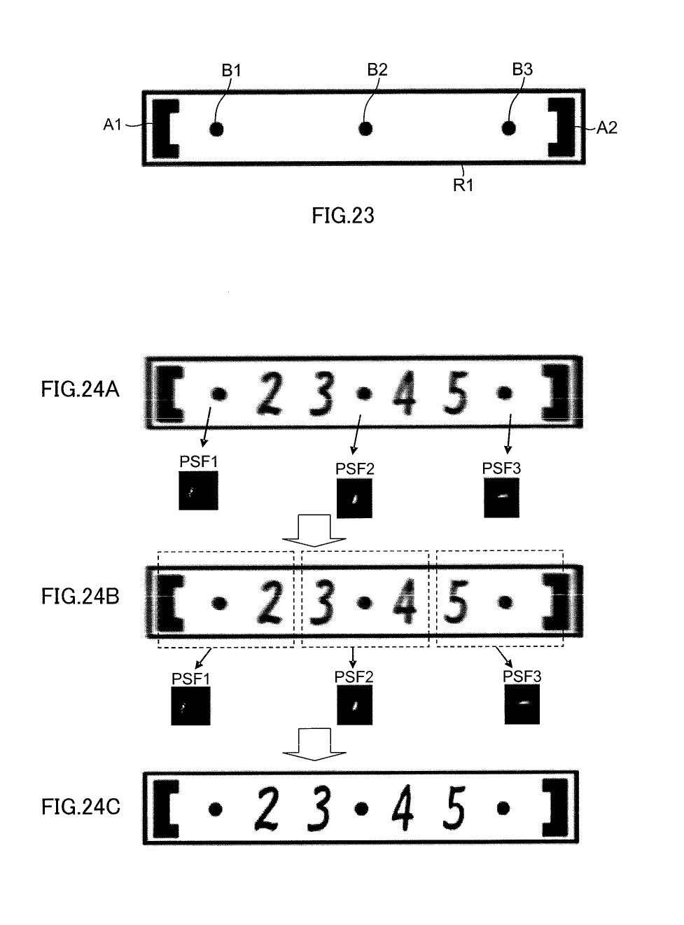

FIG. 23 shows an exemplary configuration of the document used in the present configuration. The difference from the document shown in FIG. 5 is that a plurality of PSF estimation markers B1, B2, and B3 are formed between layout markers A1 and A2.

FIG. 24 shows a process performed by image stabilization apparatus 300. First, as shown in FIG. 24A, a PSF is obtained for each PSF estimation marker. Next, as shown in FIG. 24B, the photographed image is divided into regions to which the respective PSFs are applied. As another method, it is also possible to adopt a method that recognizes each character and determines which PSF to apply for each character. According to this method, since no single character is divided into a plurality of regions, it is possible to obtain a clearer result. Next, as shown in FIG. 24C, a clear image is obtained by correcting blurring using the corresponding PSF for each separation region and then synthesizing the image after correction.

### 5. Applied Configuration 3

As shown in FIG. 5C, here is described a configuration in which, PSF estimation is performed by using a ruler line when there is no PSF estimation marker B1 on the document.

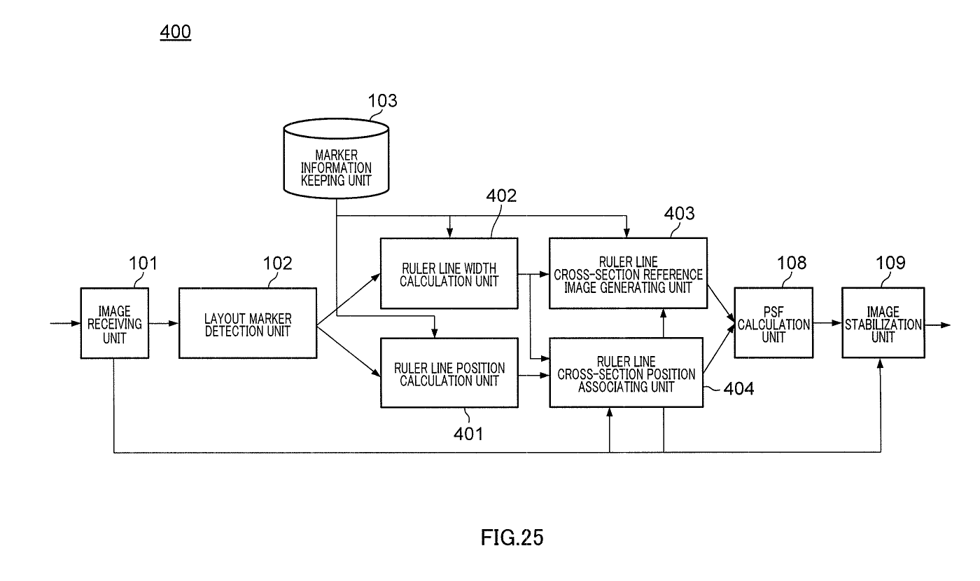

FIG. 25 shows applied configuration 3. In FIG. 25, same reference signs as FIG. 3 are applied to the components that are same as those in FIG. 3. The point where image stabilization apparatus 400 of FIG. 25 is different from the image stabilization apparatus 100 in FIG. 3 is that image stabilization apparatus 400 has ruler line position calculation unit 401, ruler line width calculation unit 402, ruler line cross-section reference image generating unit 403, and ruler line cross-section position associating unit 404.

Here, the ruler line cross-section, when the ruler line in the horizontal direction is used for the PSF estimation, refers to a plane obtained by cutting by a line segment in the vertical direction, and when the ruler line in the vertical direction is used for the PSF estimation, refers to a plane obtained by cutting by a line segment in the horizontal direction.

Ruler line position calculation unit 401 calculates the position of a ruler line (hereafter called as an estimation ruler line) to be used for PSF estimation based on the sets of coordinates of layout markers A1 and A2 detected by layout marker detection unit 102, and marker information (known layout information) kept by marker information keeping unit 103 and outputs the calculated cutting position coordinate data. Although a case is described in which reading frame R1 is used as the ruler line for PSF estimation, another ruler line that surrounds a reading target may be used. The calculation of the position of the ruler line will be described in detail later.

Ruler line width calculation unit 402 calculates the width of the ruler line based on the set of coordinates of the layout marker detected by layout marker detection unit 102, the position of the ruler line calculated by ruler line position calculation unit 401 and the marker information (known layout information) kept by marker information keeping unit 103. The calculation of the width of the ruler line will be described later in detail.

Ruler line cross-section reference image generating unit 403 generates a reference image (one-dimensional signal) of the ruler line cross-section based on the ruler line width calculated by ruler line width calculation unit 402. The process for generating the reference image of the ruler line cross-section will be described in detail later.

Ruler line cross-section position associating unit 404 cuts out a cross-section image (one-dimensional data) of the estimation ruler line from the frame memory of image receiving unit 101 based on the position of the ruler line calculated by ruler line position calculation unit 401 and the ruler line width calculated by ruler line width calculation unit 402 in association with the position of the ruler line cross-section in the photographed image corresponding to the ruler line cross-section to be a reference and keeps the cross-section image as estimation ruler line cross-section actual image data.

PSF calculation unit 108 calculates (estimates) a PSF by performing a deconvolution operation by using the ruler line cross-section reference image obtained by ruler line cross-section reference image generating unit 403 and the ruler line cross-section image (one-dimensional signal) cut out from the photographed image by ruler line cross-section position associating unit 404. PSF calculation unit 108 keeps the operation result as estimated PSF data. The estimated PSF data obtained here is also one-dimensional.

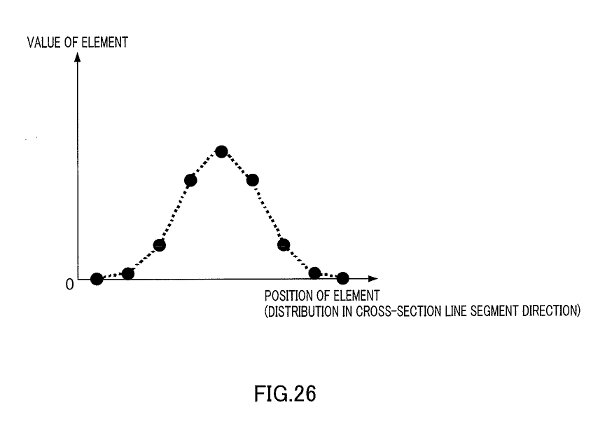

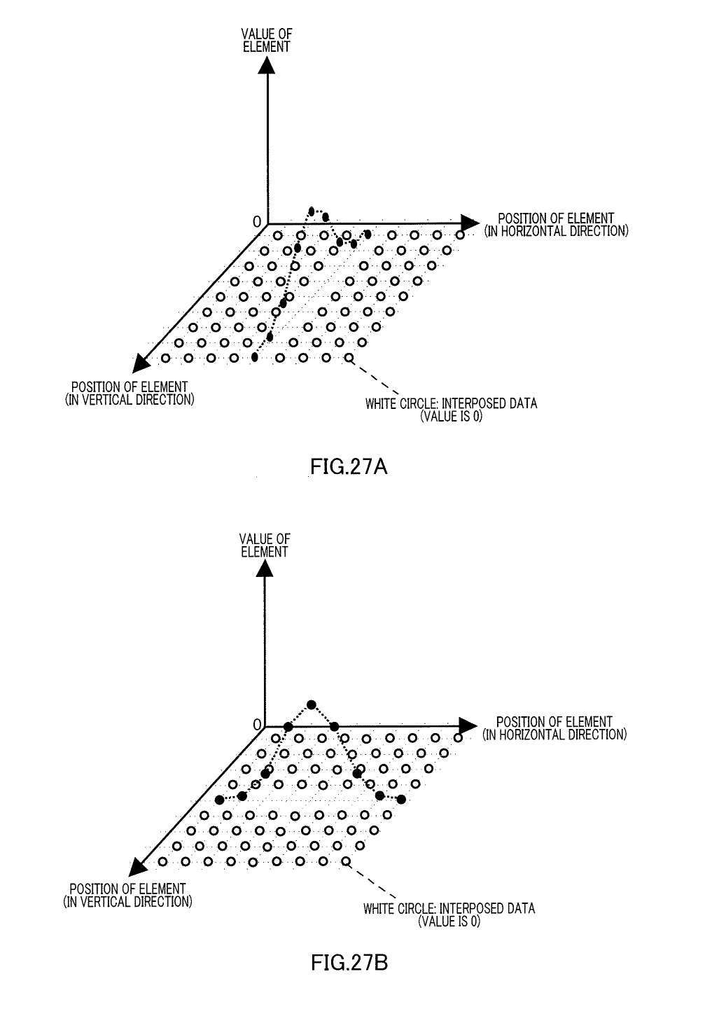

Then, ruler line cross-section reference image generating unit 403 expands the one-dimensional estimated PSF data into two-dimensional data. The operation is shown in FIG. 26 and FIG. 27. FIG. 26 shows one-dimensional PSF data obtained by deconvolution. FIG. 27 shows estimated PSF data expanded into two-dimensional data.

FIG. 27A shows estimated PSF data expanded into two dimensions where the estimation ruler line extends in the horizontal direction. FIG. 27B shows PSF data expanded into two dimensions where the estimation ruler line extends in the vertical direction. As understood from FIG. 27, data value 0 is added for expansion into two-dimensions.

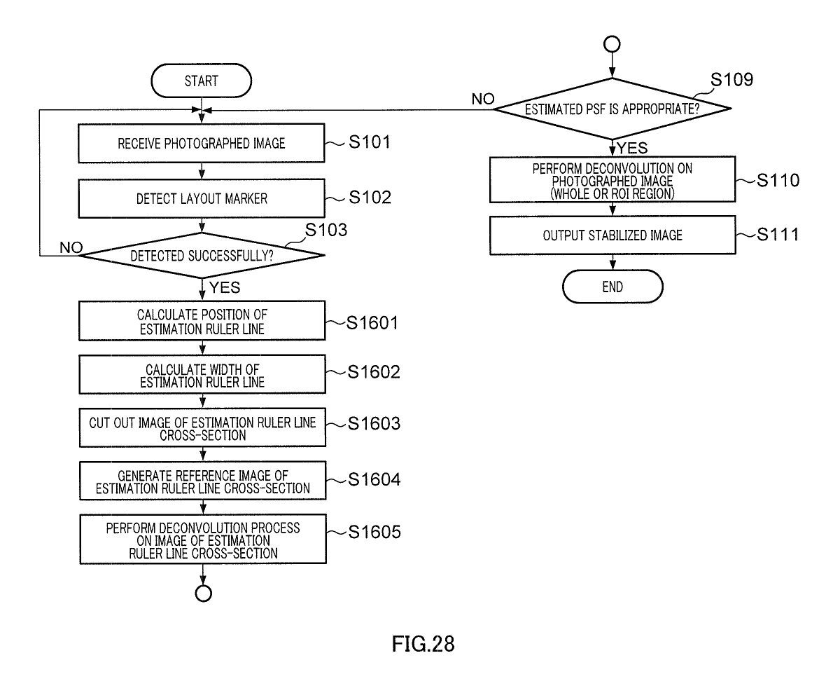

FIG. 28 shows a procedure performed by image stabilization apparatus 400. In FIG. 28, same reference signs as FIG. 4 are applied to the processes that are same as those in FIG. 4, and hereafter the explanations for the same processes as FIG. 4 are omitted.

In step S1601, a position of the estimation ruler line is calculated by ruler line position calculation unit 401, and in step S1602, the width of the estimation ruler line is calculated by ruler line width calculation unit 402.

In step S1603, an estimation ruler line cross-section image is cut out from the photographed image by ruler line cross-section position associating unit 404. In step S1604, a reference image of the estimation ruler line cross-section is generated by ruler line cross-section reference image generating unit 403.

In step S1605, PSF calculation unit 108 performs a deconvolution process on the estimation ruler line cross-section image to thereby obtain an estimated PSF. Further, the one-dimensional estimated PSF is expanded into two-dimensional estimated PSF.

### 5-1. Process for Calculating Position of Estimation Ruler Line

An explanation is given of a process for calculating the position of the estimation ruler line performed by the ruler line position calculation unit 401 in step S1601.

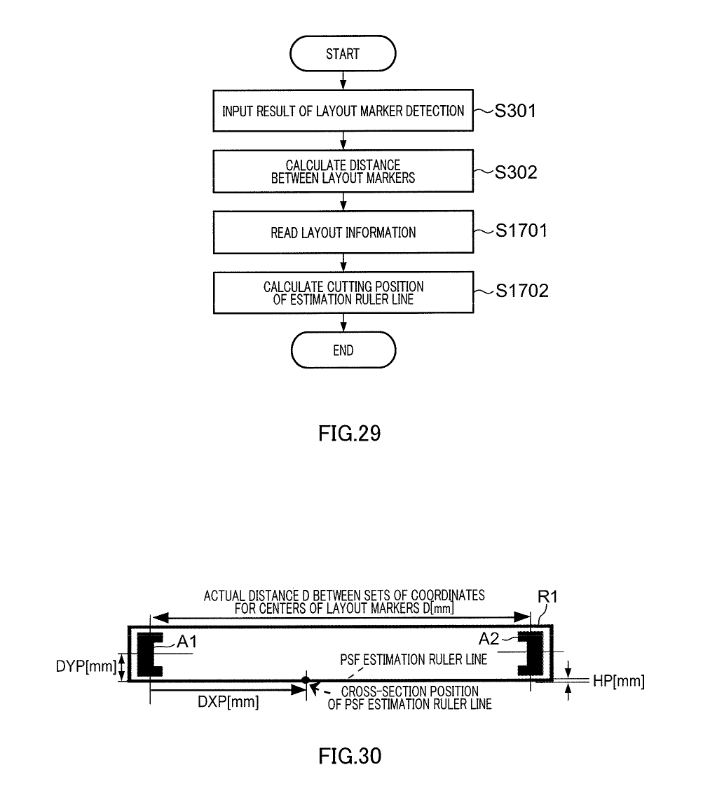

FIG. 29 is a flowchart showing a procedure for calculating the position of the estimation ruler line (that is, a flowchart showing the details of the content of the process in step S1601). In FIG. 29, same reference signs as FIG. 6 are applied to the processes that are same as those in FIG. 6, and hereafter the explanations for the same processes as FIG. 6 are omitted.

Ruler line position calculation unit 401 receives layout information in step S1701. That is, ruler line position calculation unit 401 reads and acquires the information on the layout of the document from marker information keeping unit 103.

FIG. 30 shows an example of the layout information read from marker information keeping unit 103. Layout information read by ruler line position calculation unit 401 is the following information:
Actual distance D between the layout markers on the document sheet surface
Distance to the estimation ruler line (DYP) with the center position of the layout marker as a reference.

In step S1702, ruler line position calculation unit 401 calculates the cutting position of the estimation ruler line and outputs coordinate data of the calculated cutting position. Here, when the set of coordinates of the cutting position to be calculated is (XP, YP), the set of cutting position coordinates (XP, YP) is calculated according to the following formula by using the similarity relationship between the photographed image and the document layout. The method for calculating is similar to that explained with FIG. 7.

(Equation 10)

XP=XL+cos J0·DXP·Z−sin J0·DYP·Z

YP=YL+sin J0·DXP·Z+cos J0·DYP·Z [10]
where
R0: an angle formed by a line segment connecting between the centers of the layout markers with the horizontal axis and
J0=tan⁻¹ ((YR−YL)/(XR−XL))
Z=DI/D

DXP is a position (by a unit of the size in the document layout) where the cross-section of the estimation ruler line is obtained, and any values of 0 to D may be set according to the part of the document where the estimated PSF is intended to be calculated.

### 5-2. Process for Calculating Estimation Ruler Line Width

An explanation is given of a process for calculating the estimation ruler line width calculation process performed by ruler line width calculation unit 402 in step S1602.

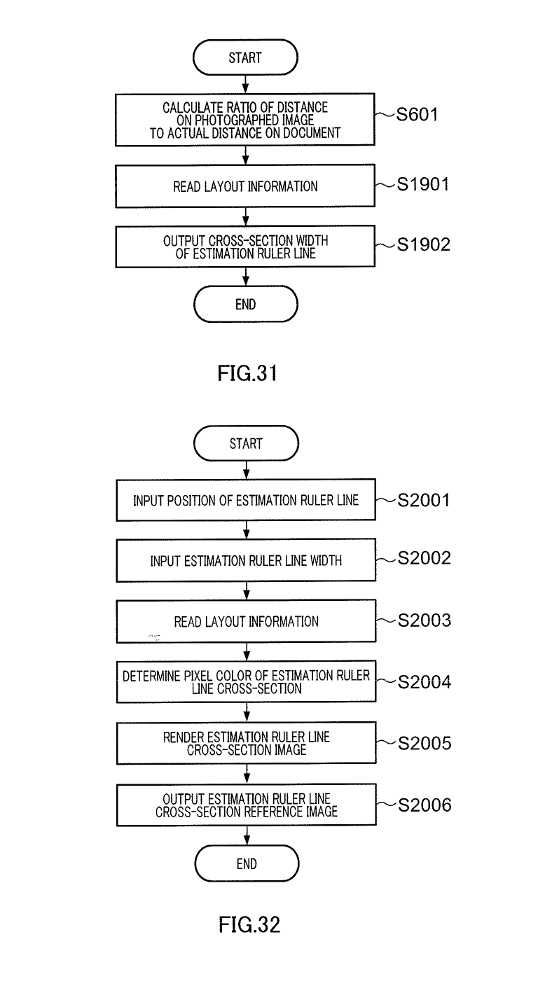

FIG. 31 is a flowchart showing a procedure for calculating the estimation ruler line width (that is, a flowchart showing the details of the process content in step S1602). In FIG. 31, same reference signs as FIG. 9 are applied to the processes that are same as those in FIG. 9, and hereafter the explanations for the same processes as FIG. 9 are omitted.

Ruler line width calculation unit 402 calculates, in step S601, ratio Z of distance DI

(FIG. 7) between layout markers A1 and A2 on the photographed image to actual distance D between layout markers A1 and A2 on the document (FIG. 30). Since distances DI and D are calculated also by ruler line position calculation unit 401, ruler line width calculation unit 402 obtains ratio Z by receiving the distances DI and D from ruler line position calculation unit 401. Further, ruler line width calculation unit 402 receives an angle of deviation J0(FIG. 7).

Ruler line width calculation unit 402 receives the layout information in step S1901. That is, ruler line width calculation unit 402 reads and acquires information on the layout of the document from marker information keeping unit 103. The layout information read by ruler line width calculation unit 402 is the following information.
Value HP of the actual ruler line width (see FIG. 30.)

In step S1902, ruler line width calculation unit 402 calculates the width (cross-section width) of the estimation ruler line on the photographed image by using the value obtained in step S601 and step S1901 and outputs the result of calculation. Ruler line width HPIC can be obtained by the following formula:

(Equation 11)

HPIC=HP·Z/cos J0 [11]

5-3. Process for Generating Reference Image of Estimation Ruler Line Cross-Section An explanation is given of a process for generating the reference image of the estimation ruler line cross-section performed by ruler line cross-section reference image generating unit 403 in step S1604.

FIG. 32 shows a flowchart showing a procedure for generating a reference image of the estimation ruler line cross-section (that is, the flowchart showing the details of the content of the process in step S1604).

In step S2001, ruler line cross-section reference image generating unit 403 receives a set of coordinates (XP, YP) of the estimation ruler line cutting position calculated in step S1702 earlier. In step S2002, ruler line cross-section reference image generating unit 403 receives estimation ruler line cross-section width HPIC calculated in step S1602 earlier.

Ruler line cross-section reference image generating unit 403 reads and acquires information on the layout of the document in step S2003 from marker information keeping unit 103. The information acquired by ruler line cross-section reference image generating unit 403 is the following information.
The color arrangement of the estimation ruler line (black on the white background and white on the black background)

In step S2004, ruler line cross-section reference image generating unit 403 reads a pixel value on the cross-section line segment specified in steps S2001 and S2002 from a frame memory of image receiving unit 101 in which a photographed image is stored, and determines the pixel color of the estimation ruler line cross-section reference image. Reading of the above is performed in such a way that a background pixel near the ruler line cross-section is included. For example, when the horizontal ruler line is used, the coordinates of the range to be read are determined as (XP, YP−delta 1)−(XP, YP+HPIC+delta 2). In the formula, delta 1 and delta 2 indicate extra portion of the heights of the background region read out below and above the ruler line. The method for determining the pixel value is similar to the method explained in step S804.

In step S2005, ruler line cross-section reference image generating unit 403 renders an estimation ruler line cross-section image. Specifically, ruler line cross-section reference image generating unit 403 first prepares an image memory (one-dimensional) having elements of the same number as that of pieces of pixel data read from the photographed image in step S2004. Then, ruler line cross-section reference image generating unit 403 renders a ruler line cross-section pattern based on the information obtained in steps S2002 and S2003 on the image memory prepared. For the pixel value corresponding to each of the patterns of white and black, each pixel value determined in step S2004 is used.

In step S2006, ruler line cross-section reference image generating unit 403 outputs data Tendered in step S2005 as the estimation ruler line cross-section reference image.

### 6. Applied Configuration 4

In the present configuration, a point image of one dot is used as a PSF estimation marker. As described in patent literature 2, this makes it possible to utilize the photographed image of a point image of one dot as a PSF without any processing when the PSF is obtained. Therefore, the calculation amount can be small. When a point image having a plurality of dots is used, a deconvolution process will be necessary, and therefore the amount of calculation becomes large. Here, one dot refers to a minimum pixel of the camera used in photographing the photographed image (for example, one light receiving element of CCD).

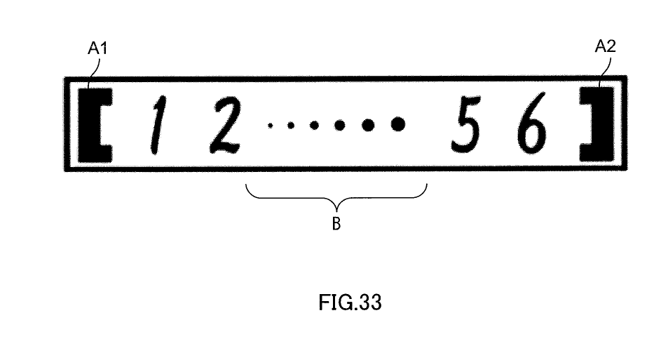

FIG. 33 shows an exemplary configuration of the document used in applied configuration 4. PSF estimation marker B is formed of a plurality of point images having different sizes. Then, the image stabilization apparatus of the present configuration estimates the sizes of a plurality of point images by using the layout markers A1 and A2 and extracts an image of 1 dot from among the plurality of point images. By using the PSF estimation marker extracted, it is made possible to obtain a PSF with a small amount of calculation.

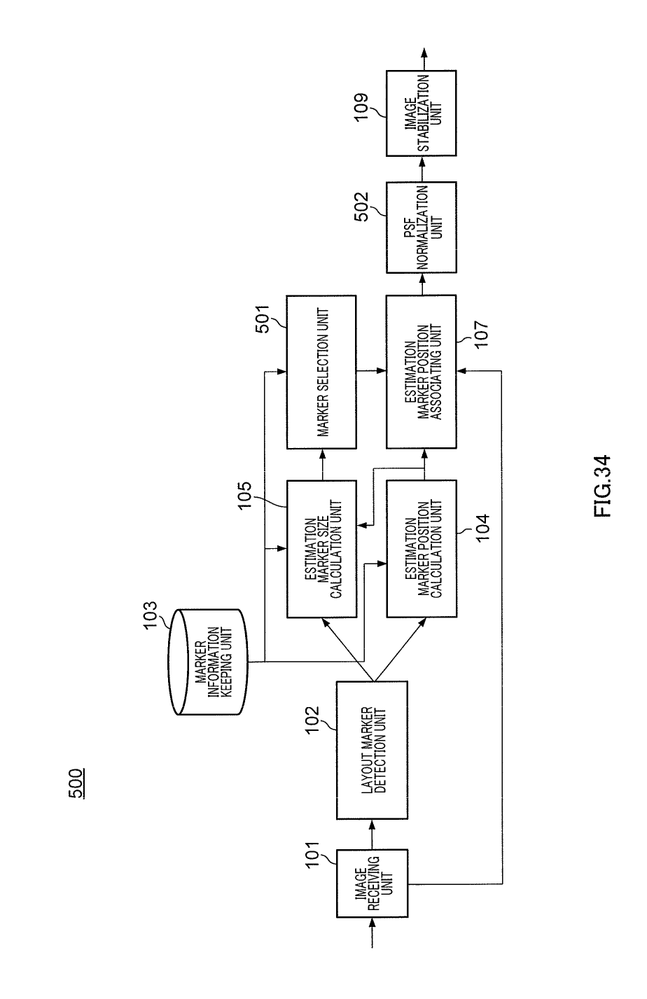

FIG. 34 shows applied configuration 4. In FIG. 34, same reference signs as FIG. 3 are applied to the components that are the same as those in FIG. 3. Image stabilization apparatus 500 of FIG. 34 has a marker selection unit 501 and a PSF normalization unit 502.

Estimation marker size calculation unit 105 estimates the sizes of a plurality of point images (FIG. 33) by using layout markers A1 and A2 and outputs the estimation result to marker selection unit 501.

Marker selection unit 501 selects an image photographed by one dot from among the plurality of point images based on the size estimation result.

Estimation marker position associating unit 107 associates the position of the estimation marker in the photographed image based on the position of the estimation marker selected by marker selection unit 501 and cuts out the image.

PSF normalization unit 502 normalizes a signal level of each pixel of the marker region image (approximately PSF image) cut out by estimation marker position associating unit 107. Specifically, the following process is performed.
First, when a black PSF estimation marker is formed on the white background, the white and black of the marker region image are inverted. When a white PSF estimation marker is formed on the black background, the inversion is not necessary.
Next, the signal level of the whole of the image is uniformly lowered so that the signal level of the black background becomes 0. Thus-obtained result is used as an estimated PSF.

### 7. Effects of Embodiment

It is made possible to perform highly accurate image stabilization with a relatively small amount of operations, and a simple configuration as well as easy user operations by the configuration including: layout marker detection unit 102 that detects a layout marker from a photographed image; estimation marker position calculation unit 104 that obtains the position of the PSF estimation marker; estimation marker size calculation unit 105 that obtains the size of the PSF estimation marker; estimation marker reference image generating unit 106 that generates an image of the PSF estimation marker to be a reference; PSF calculation (estimation) unit 108 that estimates a PSF by using the estimation marker image to be a reference and an estimation marker image corresponding thereto in the photographed image; and image stabilization unit 109 that corrects blurring in the photographed image by using the estimated PSF.

In other words, according to the present embodiment, blurring can be corrected based on one still image with a small amount of operations and high accuracy. Further, it is made possible to correct blurring without any additional sensor. Further, any extra photographing steps can be made unnecessary since the PSF is estimated at the same time as photographing the subject. Further, it is made possible to correct blurring without fixing the positional relationship between the camera and the subject. Further, not only it is made possible to correct the blurring in an image caused by the camera shake at photographing, but also to correct the blurring in an image attributable to a condition of a photographic target such as a document or the like.

Image stabilization apparatuses 100, 200, 300, 400, and 500 of the above embodiments can be formed of a computer such as a personal computer including a memory and a CPU. Then, the functions of constituent elements of image stabilization apparatuses 100, 200, 300, 400 and 500 can be realized by reading a computer program stored in a memory, by a CPU.

The disclosure of Japanese Patent Application No. 2011-134926 filed on Jun. 17, 2011, including the specification, drawings and abstract, is incorporated herein by reference in its entirety.

### INDUSTRIAL APPLICABILITY

The present invention is useful for an apparatus in which a document or the like is photographed by, for example, a portable terminal having a camera such as a hand-held terminal and the photographed image is subjected to image recognition.

### REFERENCE SIGNS LIST

100, 200, 300, 400, 500 image stabilization apparatus
101 image receiving unit
102 layout marker detection unit
103 marker information keeping unit
104 estimation marker position calculation unit
105 estimation marker size calculation unit
106 estimation marker reference image generating unit
107 estimation marker position associating unit
108 PSF calculation unit
109 image stabilization unit
201 distortion detection unit
301 region dividing unit
302 optimal PSF associating unit
303 synthesizing unit
401 ruler line position calculation unit
402 ruler line width calculation unit
403 ruler line cross-section reference image generating unit
404 ruler line cross-section position associating unit
501 marker selection unit
502 PSF normalization unit
A1, A2 layout marker
B, B1, B2, B3 PSF estimation marker
L1 character entry area
R1 reading frame

1. An image stabilization apparatus comprising:
an image receiving unit that receives a photographed image including a layout marker and a PSF estimation marker;
a layout marker detection unit that detects a layout marker from the photographed image;
a marker information keeping unit that keeps information on the layout marker;
an estimation marker position calculation unit that obtains a position of the PSF estimation marker based on a result of layout marker detection obtained by the layout marker detection unit and the information on the layout marker kept in the marker information keeping unit;
an estimation marker size calculation unit that obtains a size of the PSF estimation marker based on the result of layout marker detection obtained by the layout marker detection unit and the information on the layout marker kept by the marker information keeping unit;
an estimation marker reference image generating unit that generates an image of the PSF estimation marker to be a reference based on the size of the PSF estimation marker obtained by the estimation marker size calculation unit;
an estimation marker position associating unit that associates a position of the image of the PSF estimation marker to be the reference obtained by the estimation marker reference image generating unit with a position of the image of the PSF estimation marker in the photographed image based on the position of the PSF estimation marker obtained by the estimation marker position calculation unit;
a PSF estimation unit that estimates a PSF by using the image of the PSF estimation marker to be the reference and the image of the PSF estimation marker in the photographed image, which are associated with each other by the estimation marker position associating unit; and
an image stabilization unit that corrects blurring in the photographed image by using the estimated PSF.

2. The image stabilization apparatus according to claim 1, further comprising a distortion detection unit that detects distortion of the photographed image, wherein
the estimation marker reference image generating unit reflects the distortion detected by the distortion detection unit on the image of the PSF estimation marker to be the reference.

3. The image stabilization apparatus according to claim 1, wherein
the photographed image includes a plurality of PSF estimation markers, the PSF estimation unit estimates a PSF for each of the PSF estimation markers, and
the image stabilization apparatus further comprises:
a region dividing unit that divides the photographed image into a plurality of regions according to positions of the plurality of PSF estimation markers obtained by the estimation marker position calculation unit;
an optimal PSF associating unit that associates the PSF of each of the PSF estimation markers estimated by the PSF estimation unit with a corresponding one of the regions obtained by the region dividing unit; and
a synthesizing unit that synthesizes the images of the respective regions in which blurring is corrected by the image stabilization unit, and
the image stabilization unit corrects blurring in each of the regions by using the PSF associated with the region.

4. The image stabilization apparatus according to claim 1, wherein
the PSF estimation marker is a ruler line,
the estimation marker position calculation unit is a ruler line position calculation unit that obtains a position of the ruler line based on the result of layout marker detection obtained by the layout marker detection unit and the information on the layout marker kept in the marker information keeping unit,
the estimation marker size calculation unit is a ruler line width calculation unit that obtains a width of the ruler line based on the result of layout marker detection obtained by the layout marker detection unit and the information on the layout marker kept in the marker information keeping unit,
the estimation marker reference image generating unit generates a ruler line to be the reference based on the width of the ruler line obtained by the ruler line width calculation unit,
the estimation marker position associating unit associates a ruler line image to be the reference obtained by the estimation marker reference image generating unit with the ruler line image in the photographed image, based on the position of the ruler line obtained by the ruler line position calculation unit, and
the PSF estimation unit estimates the PSF by using the ruler line image to be the reference and the ruler line image in the photographed image, which are associated with each other by the estimation marker position associating unit.

5. The image stabilization apparatus according to claim 1, wherein
the PSF estimation markers are a plurality of point images different in size from one another,
the estimation marker position calculation unit obtains positions of the plurality of point images based on the result of layout marker detection obtained by the layout marker detection unit and the information on the layout marker kept by the marker information keeping unit,
the estimation marker size calculation unit obtains sizes of the plurality of point images based on the result of layout marker detection obtained by the layout marker detection unit and the information on the layout marker kept in the marker information keeping unit,
the estimation marker reference image generating unit selects, as a PSF estimation marker to be the reference, a point image of one dot from among the plurality of point images based on the sizes of the plurality of point images obtained by the estimation marker size calculation unit,
the estimation marker position associating unit cuts out a point image in the photographed image, the point image corresponding to the position of the point image selected by the estimation marker reference image generating unit, and the PSF estimation unit estimates the PSF by normalizing the point image cut out by the estimation marker position associating unit.

6. The image stabilization apparatus according to claim 1,
wherein the PSF estimation unit estimates the PSF by a deconvolution process using the image of the PSF estimation marker to be the reference and the image of the PSF estimation marker in the photographed image, which are associated with each other by the estimation marker position associating unit.

7. An image stabilization method comprising:
a layout marker detection step of detecting a layout marker from a photographed image including a layout marker and a PSF estimation marker;
an estimation marker position calculation step of obtaining a position of the PSF estimation marker based on the detected layout marker;
an estimation marker size calculation step of obtaining a size of the PSF estimation marker based on the detected layout marker;
an estimation marker reference image generating step of generating an image of the PSF estimation marker to be a reference based on the calculated size of the PSF estimation marker;
an estimation marker position associating step of associating a position of the generated image of the PSF estimation marker to be the reference and a position of the image of the PSF estimation marker in the photographed image based on the calculated position of the PSF estimation marker;
a PSF estimation step of estimating a PSF by using the image of the PSF estimation marker to be the reference and the image of the PSF estimation marker in the photographed image, which are associated with each other; and
an image stabilization step of correcting blurring in the photographed image by using the estimated PSF.

8. A document,
of which a photographed image is input to the image stabilization apparatus according to claim 1, the document comprising:
a reading frame;
a character entry area provided within the reading frame;
first and second layout markers respectively formed at positions within the reading frame, the positions being located across the character entry area from one another; and
a PSF estimation marker formed at a position within the reading frame and between the first and second layout markers.

9. The document according to claim 8,
wherein the PSF estimation marker is formed at a center position within the reading frame.

10. The document according to claim 8, wherein the PSF estimation marker is a closed figure.
